(19) United States
(12) Patent Application Publication
(10) Pub. No.: US 2026/0368660 A1
(43) Pub. Date: Nov. 19, 2026

(54) CANDIDATE-EMPLOYER MATCHING SYSTEM AND METHOD

(71) Applicant: JobLasso Co., Omaha, NE (US)

(72) Inventors: Mosah F. Goodman, Omaha, NE (US); Brian J. Rea, Omaha, NE (US)

(73) Assignee: JobLasso Co., Omaha, NE (US)

(21) Appl. No.: 19/677,164

(22) Filed: May 14, 2026

Related U.S. Application Data
(60) Provisional application No. 63/805,754, filed on May 14, 2025.

(51) Int. Cl. G06Q 10/0631; G06F 21/62; G06Q 10/1053; H04L 9/40

(52) U.S. Cl. CPC G06Q 10/063112; G06F 21/6245; G06Q 10/1053; H04L 63/10

(57) ABSTRACT

A system and method for matching job candidates with employment opportunities is provided. The system and method may include receiving, by a server, employer questionnaire data comprising employer responses to questions associated with a job posting, wherein each employer response indicates an evaluation designation for response options and each question is assigned an employer-defined priority weight. The system and method may further include receiving candidate questionnaire data comprising candidate responses to the questions. For each question, the server may compare the candidate response to the employer response to determine a match type comprising an exact match, a partial match, or no match, and assigns a match score based on the match type. The server may then calculate a weighted score by multiplying the match score by the priority weight, calculate a total candidate score by summing the weighted scores, calculate a match percentage by dividing the total candidate score by a maximum possible score, and transmit the match percentage to a client device.

### CROSS-REFERENCE TO RELATED APPLICATIONS

This application claims priority under 35 U.S.C. § 119 to U.S. Application No. 63/805,754, titled CANDIDATE-EMPLOYER MATCHING SYSTEM AND METHOD, filed May 14, 2025, which is hereby incorporated by reference in its entirety.

### FIELD OF INVENTION

The present disclosure relates to computerized employment matching systems, and more particularly to a candidate-employer matching system and method that utilizes questionnaire-based scoring to match job candidates with employment opportunities while providing confidentiality features that enable candidates and employers to maintain control over personal and professional data.

### BACKGROUND

Employment recruiting has traditionally relied on various tools and methods to connect job candidates with potential employers. These tools may include recruiters who target job candidates for open positions, online job boards, job fairs, and job postings on employer websites. Many existing recruiting platforms depend on unstructured information such as resumes, job descriptions, and keyword-based searches to identify potential candidate-job matches. Because these systems often rely on text-based data, the matching process may involve manual review and can produce inconsistent or incomplete evaluations of candidate qualifications relative to job requirements.

While exploring employment opportunities through conventional recruiting tools, job candidates may face challenges in maintaining control over their personal and professional data, including how and to whom such information is disseminated. Many professionals prefer to explore new employment opportunities while maintaining confidentiality, particularly when they are currently employed. Traditional recruiting platforms often involve candidates disclosing identifying information early in the process, which can discourage participation or limit open exploration of opportunities. If a candidate's data is shared in an unintended manner and reaches their current employer, it may jeopardize the candidate's existing employment situation.

Employers seeking job candidates may also face challenges with conventional recruiting approaches. Employers often spend considerable time and resources reviewing resumes and interviewing candidates who may ultimately be unqualified or unserious about a particular job opening. In many cases, candidates provided to employers through conventional recruiting approaches may lack the skills that match the employment opportunity's requirements. Additionally, employers may have concerns about their own personal and professional data being shared with competitors or other unintended parties.

These factors may contribute to skepticism and frustration among both job candidates and employers regarding conventional recruiting tools due to concerns about trust and efficiency in the hiring process. Accordingly, there is a desire for improved systems that provide a structured framework for evaluating candidate-job alignment while also allowing users to control when and how identifying information is shared.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for matching job candidates with employment opportunities is provided. The method may include receiving, by a server, employer questionnaire data comprising a plurality of employer responses to a plurality of questions associated with a job posting, wherein each employer response indicates an evaluation designation for each of a plurality of response options, and wherein each question is assigned an employer-defined priority weight. The method may further include receiving, by the server, candidate questionnaire data comprising a plurality of candidate responses to the plurality of questions, wherein the plurality of questions in the candidate questionnaire data correspond to the plurality of questions in the employer questionnaire data. For each question in the plurality of questions, the method may comprise comparing, by the server, the candidate response to the employer response to determine a match type, wherein the match type comprises one of an exact match, a partial match, or no match. The method may also include assigning, by the server, a match score to each question based on the determined match type, calculating, by the server, a weighted score for each question by multiplying the match score by the employer-defined priority weight assigned to the question, calculating, by the server, a total candidate score by summing the weighted scores for all questions, calculating, by the server, a match percentage by dividing the total candidate score by a maximum possible score, and transmitting, by the server, the match percentage to a client device for display in a user interface.

According to another aspect of the present disclosure, a method for controlling access to candidate profile data in a candidate-employer matching system is provided. The method may include maintaining, by a server, candidate profile data comprising publicly visible information and private information associated with a candidate, wherein the publicly visible information is viewable by employers and the private information is restricted from employer access until the candidate authorizes disclosure. The method may further include receiving, by the server, a request from an employer device for candidate profile data, and determining, by the server, whether the candidate has authorized disclosure of the private information to the employer. When the candidate has not authorized disclosure, the method may include restricting, by the server, the employer to viewing the publicly visible information. When the candidate has authorized disclosure, the method may include permitting, by the server, the employer to view the private information.

According to another aspect of the present disclosure, a candidate-employer matching system is provided. The system may include a server comprising a processor and a memory, and a database communicatively coupled to the server. The system may further include a candidate-employer matching application executable by the processor and configured to receive employer questionnaire data comprising employer responses to a plurality of questions associated with a job posting, wherein each question is assigned an employer-defined priority weight, receive candidate questionnaire data comprising candidate responses to the plurality of questions, calculate a match percentage by comparing the candidate responses to the employer responses and applying the employer-defined priority weights, and transmit the match percentage to a client device. The system may also include a plurality of confidentiality features configured to safeguard personal and professional data for job candidates and employers, the plurality of confidentiality features comprising at least one of anonymous job matching, job candidate controlled profile visibility, or secure messaging and profile access control.

The foregoing general description of the illustrative embodiments and the following detailed description thereof are merely exemplary aspects of the teachings of this disclosure and are not restrictive.

### Objects, Features, and Advantages

It is a principal object, feature, and advantage of the present disclosure to provide an improved system and method for matching job candidates with employers that may utilize structured questionnaire-based scoring with employer-defined weighted criteria, rather than relying on unstructured information such as resumes, job descriptions, and keyword-based searches that produce inconsistent or incomplete evaluations of candidate qualifications relative to job requirements.

Another object, feature, and advantage of the present disclosure may provide a server-level access control architecture that enforces privacy restrictions at the database query level based on candidate-employer connection status, blocking access to private profile data when no connection exists and automatically revoking access when a connection ends, rather than relying on user interface-level hiding of information that may be bypassed through direct database queries or application programming interface calls.

Yet another object, feature, and advantage of the present disclosure may provide threshold-based engagement controls that automatically disable or enable user interface elements such as Express Interest, Not Interested, and Share Resume buttons based on computed match percentages, ensuring that engagement between candidates and employers occurs only when a meaningful level of compatibility exists between the candidate's qualifications and the employer's defined requirements.

A further object, feature, and advantage of the present disclosure may provide a data storage architecture that separates public candidate information from private candidate information into distinct storage locations, with public data stored in a user profiles table and private data stored in separate tables for resumes, experiences, and education, enabling data-level access control enforcement based on connection status.

A still further object, feature, and advantage of the present disclosure may provide real-time or near real-time match recalculation through an event-driven architecture that automatically recalculates match scores for all affected candidate-job pairs when a candidate or employer creates or updates a questionnaire, and dynamically updates user interface engagement controls and sends threshold-crossing notifications to users in near real-time.

### BRIEF DESCRIPTION OF FIGURES

Non-limiting and non-exhaustive examples are described with reference to the following figures.

FIG. 1 illustrates a system architecture diagram of a candidate-employer matching system, according to aspects of the present disclosure.

FIG. 2 illustrates a block diagram of a candidate-employer matching application and confidentiality features, according to aspects of the present disclosure.

FIG. 3 illustrates a data storage architecture showing separate storage for public and private candidate data, according to aspects of the present disclosure.

FIG. 4 illustrates a flowchart of a method for configuring an employer questionnaire, according to aspects of the present disclosure.

FIG. 5 illustrates a flowchart of a method for completing a candidate questionnaire, according to aspects of the present disclosure.

FIG. 6 illustrates an entity-relationship diagram of a questionnaire version tracking data model, according to aspects of the present disclosure.

FIG. 7 illustrates a flowchart of a method for calculating a candidate match percentage, according to aspects of the present disclosure.

FIG. 8 illustrates a worked example of a candidate match percentage calculation, according to aspects of the present disclosure.

FIG. 9 illustrates a flowchart of a method for near real-time match recalculation, according to aspects of the present disclosure.

FIG. 10 illustrates a threshold-based engagement control diagram, according to aspects of the present disclosure.

FIG. 11 illustrates a connection lifecycle and access control diagram, according to aspects of the present disclosure.

FIG. 12 illustrates a candidate profile visibility control interface, according to aspects of the present disclosure.

FIG. 13 illustrates an employer blocking and access control diagram, according to aspects of the present disclosure.

FIG. 14 illustrates an end-to-end user flow diagram for candidates and employers, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure describes a candidate-employer matching system implemented as a computerized platform that facilitates structured matching between job candidates and employment opportunities. The candidate-employer matching system utilizes a questionnaire-based scoring approach combined with confidentiality features that enable candidates and employers to maintain control over personal and professional data throughout the matching and engagement process.

As described in the Background section, conventional recruiting platforms may depend on unstructured information and keyword-based searches that can produce inconsistent evaluations of candidate qualifications. In contrast, the candidate-employer matching system of the present disclosure employs a structured questionnaire framework in which both employers and candidates provide responses to standardized questions associated with specific job titles or role categories.

Employers may create job postings and complete questionnaires that include predefined questions with selectable response options representing qualifications, experience levels, and professional preferences for a role. Employers may evaluate each response option based on how well the response option aligns with job requirements and may assign priority levels to questions, such as designations indicating whether a criterion is of high, medium, or low priority. These priority levels determine the relative weight applied to each criterion during a matching calculation.

Candidates may complete corresponding questionnaires by selecting responses that describe the candidate's qualifications, experience, and professional preferences. Candidate responses may be stored as structured data and used as inputs to a compatibility scoring process. The candidate-employer matching system may calculate a compatibility score by comparing candidate responses to employer-defined criteria. Each candidate response may receive a match score depending on how the response aligns with the employer's evaluation of that response option. For example, an exact match may receive a score of 1.0, a partial match may receive a score of 0.5, and a non-matching response may receive a score of 0.0. Each match score may be multiplied by the priority weight assigned to the corresponding question. The resulting weighted scores may be aggregated to produce a total candidate score, which may then be divided by a maximum possible score to calculate a match percentage representing the degree of alignment between the candidate and the job requirements.

The candidate-employer matching system may incorporate threshold-based engagement controls that regulate interaction between candidates and employers. While job opportunities may be visible to candidates, the system may restrict the ability to express interest in a job until the compatibility score meets or exceeds a predefined matching threshold. In some cases, the system may automatically disable or gray out an engagement control element, such as an “Express Interest” button, when a candidate's match score is below the threshold, and may enable the engagement control element once the score meets the threshold. This threshold-based mechanism helps ensure that engagement between candidates and employers occurs when a level of compatibility exists between the candidate and the employer's defined requirements.

The candidate-employer matching system may also incorporate confidentiality and access-control features that regulate the visibility of candidate information. Candidate profiles may include both public information and private information. Public information may include general background descriptions, while private information may include identifying and detailed professional information such as name, contact information, resume, employment history, and education history. Private information may remain hidden until the candidate authorizes disclosure to a specific employer.

In some cases, the candidate-employer matching system may store public data and private data in separate storage locations. The system may enforce access rules at the server level based on connection status between a candidate and an employer. For example, the system may block access to private profile data at the server level when no connection exists between a candidate and an employer, and may automatically revoke access when a connection ends. This server-level access enforcement provides a technical security architecture in which private data queries are rejected by the server when connection status does not authorize access, rather than relying on user interface-level hiding of information.

Candidates who have established a connection with an employer may selectively authorize disclosure of additional information or a full profile to that specific employer. Candidates may also determine which profile elements are visible to employers prior to establishing a connection and may revoke previously granted access to private information at any time. In some cases, candidates may designate specific employers who are prevented from discovering or accessing the candidate's profile, and the system may enforce this restriction at the data level by filtering those employers out of search results involving the candidate.

The combination of the structured questionnaire framework, weighted scoring algorithm, threshold-based engagement controls, and server-level access enforcement provides a computerized system for candidate-employer matching that utilizes structured data inputs and automated scoring calculations while enabling users to control when and how identifying information is shared during the matching and engagement process.

While certain aspects of the present disclosure are shown and described herein, it is understood that such aspects are merely exemplary. The present disclosure is not intended to be limited to these specific aspects and may encompass other aspects or embodiments. Therefore, specific system and apparatus details disclosed herein are not to be interpreted or inferred as limiting, but merely as a basis for the claims and as a representative basis for teaching one skilled in the art how to make and use the disclosed subject matter.

It must further be noted that the singular terms “a,” “an,” and “the” as used herein may include plural referents unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means.

All words of approximation as used in the present disclosure and claims should be construed to mean “approximate,” rather than “perfect” or “exact,” and may be used as a modifier to any other word, number, quantity, quality, value, or specified parameter. Words of approximation, include, but are not limited to terms such as “about,” “approximately,” “around,” “almost,” “generally,” “largely,” “essentially,” “substantially,” etc. As used herein, in some aspects, the terms “about” or “approximately” when preceding a numerical value may indicate the value plus or minus a range of 1, 2, 3, 4, or 5 percentage points when referring to match percentages or matching percentage thresholds. In other aspects, the terms “about” or “approximately” when preceding a numerical value may indicate the value plus or minus a range of 0.5 or 1 when referring to question weights or priority values. In further aspects, the terms “about” or “approximately” when preceding a numerical value may indicate the value plus or minus a range of 1, 2, 5, 10, or 30 seconds when referring to recalculation latency or processing time. In still further aspects, the terms “about” or “approximately” when preceding a numerical value may indicate the value plus or minus a range of 1, 2, 5, or 10 percentage points when referring to matching percentage thresholds. In some aspects, the terms “about” or “approximately” when preceding a numerical value may indicate the value plus or minus a range of 1, 2, or 3 when referring to a number of questionnaire questions. In other aspects, the terms “about” or “approximately” when preceding a numerical value may indicate the value plus or minus a range of 1, 2, 5, or 10 minutes when referring to cache expiration periods or polling intervals.

As used herein, the term “near real-time” refers to processing or data transmission that occurs with minimal perceptible delay following a triggering event, such as within a period of seconds or minutes, rather than requiring instantaneous processing. Near real-time processing may involve latency attributable to network transmission, database operations, queue processing, or computational load, but the delay is sufficiently short that users perceive the system response as timely and responsive. The term “near real-time” does not require zero-latency or instantaneous response, but rather indicates that the system processes and delivers updates without requiring manual refresh or significant waiting periods by the user.

Furthermore the transitional phrase “comprising” that is synonymous with “including,” “containing,” and “characterized by” as used herein is inclusive or open-ended and does not exclude additional, unrecited elements, steps or ingredients. Alternatively the transitional phrase “consisting of” as used herein is closed and excludes any element, step or ingredient not specified. The transitional phrase “consisting essentially of” limits the scope of a claim to the specified materials or steps and those that do not materially affect the basic and novel characteristics of the claims.

The following detailed description provides additional aspects and embodiments of the disclosed candidate-employer matching system and method.

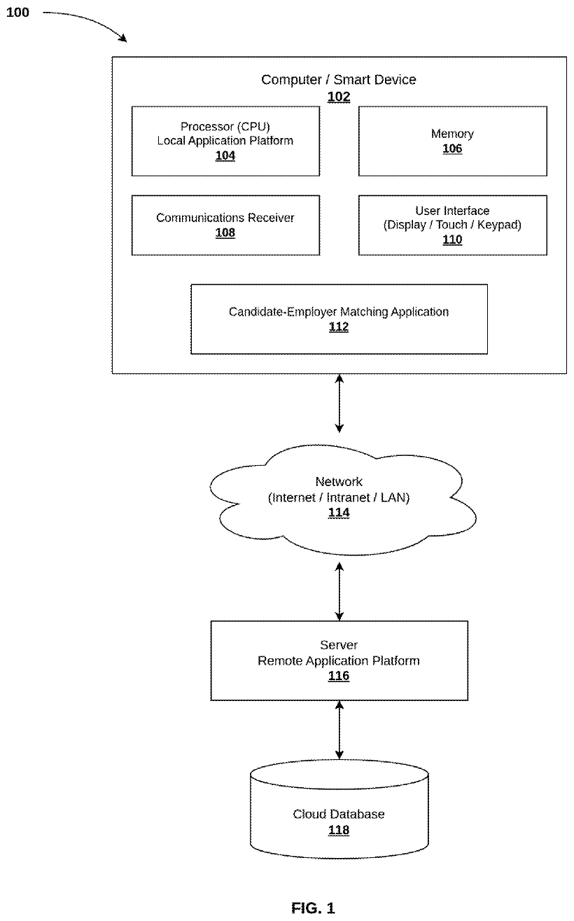

FIG. 1 illustrates a system architecture diagram of a candidate-employer matching system 100. Candidate-employer matching system 100 may be implemented on a computer or smart device 102. Computer/smart device 102 may include a processor 104, a memory 106, a communications receiver 108, and a user interface 110. Processor 104 may act as a local application platform on which to run a candidate-employer matching application 112. Candidate-employer matching application 112 may execute on processor 104 in conjunction with memory 106 and user interface 110.

User interface 110 of computer/smart device 102 may comprise a display screen and input capabilities such as a touch screen or keypad. In some cases, user interface 110 may include both a display screen with touch screen functionality and a keypad input.

Communications receiver 108 may connect computer/smart device 102 with a network 114. Network 114 may comprise the Internet, an intranet, or a local area network. Communications receiver 108 may connect computer/smart device 102 to network 114 in either a wired or wireless fashion. In some cases, communications receiver 108 may utilize wireless communication protocols including Bluetooth, Wi-Fi, cellular, or satellite communication.

Network 114 may connect computer/smart device 102 to a server 116. Server 116 may act as a remote application platform on which to run candidate-employer matching application 112. In some cases, candidate-employer matching application 112 may execute on processor 104 as a local application platform while server 116 provides remote application platform functionality for candidate-employer matching application 112.

Server 116 may be connected to a cloud database 118. Cloud database 118 may store and retrieve matching data associated with candidate-employer matching application 112. Server 116 may provide a connection between computer/smart device 102 and cloud database 118 over network 114.

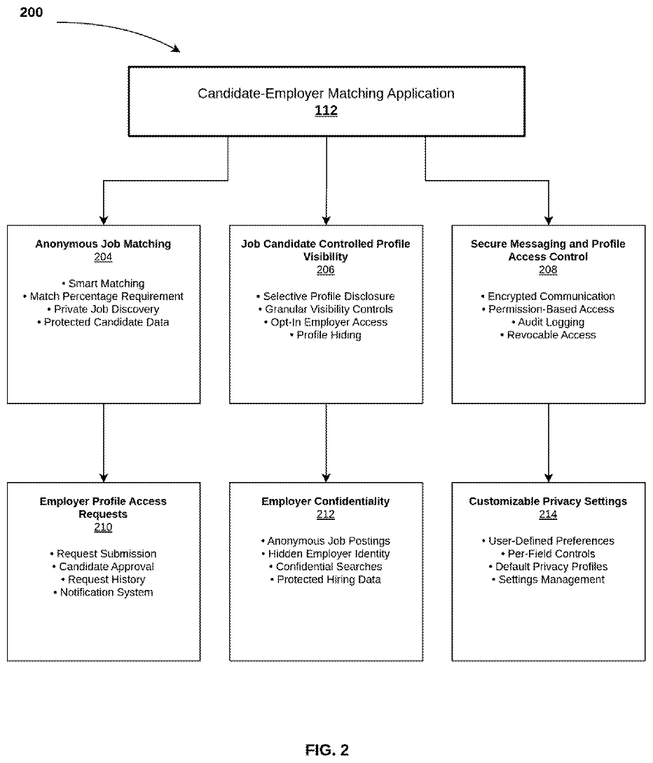

FIG. 2 illustrates a block diagram of the candidate-employer matching application 112 and a plurality of confidentiality features 200. The candidate-employer matching application 112 may include an anonymous job matching module 204, a job candidate controlled profile visibility module 206, a secure messaging and profile access control module 208, an employer profile access requests module 210, an employer confidentiality module 212, and a customizable privacy settings module 214. The plurality of confidentiality features 200 may collectively provide privacy controls for both candidates and employers throughout the matching and engagement process.

The anonymous job matching module 204 may provide smart matching functionality that utilizes structured questionnaire data rather than keyword matching or generic algorithms. The anonymous job matching module 204 may connect candidates and employers based on responses to job-specific questionnaires, resulting in candidate-employer alignment based on structured qualitative data. In some cases, the anonymous job matching module 204 may enforce a match percentage requirement such that candidates and employers meeting a minimum match threshold may engage with one another. The anonymous job matching module 204 may also provide private job discovery functionality that allows candidates to explore employment opportunities without revealing candidate identity until a moment chosen by the candidate when engaging with an employer about a job opening. The anonymous job matching module 204 may further provide protected candidate data functionality configured to restrict employers from accessing a candidate's personal and professional data until details are explicitly chosen to be shared by the candidate with the employer.

The job candidate controlled profile visibility module 206 may provide selective profile disclosure functionality that allows candidates to determine which profile elements are visible to employers. In some cases, the job candidate controlled profile visibility module 206 may provide granular visibility controls that allow candidates to adjust privacy settings at any time to manage what particular information is shared with an employer. The job candidate controlled profile visibility module 206 may provide opt-in employer access functionality such that employers are prevented from viewing a candidate's profile unless granted permission by the candidate. The job candidate controlled profile visibility module 206 may also provide profile hiding functionality where candidate profiles may be designated as private and thus remain hidden until the candidate expressly chooses to share the candidate's profile publicly or to particular employers.

The secure messaging and profile access control module 208 may provide a built-in messaging system that allows employers and candidates to communicate instantly with connections beginning the moment mutual interest is established. In some cases, the secure messaging and profile access control module 208 may provide encrypted communication functionality for secure exchange of messages between candidates and employers. The secure messaging and profile access control module 208 may allow candidates and employers to communicate together within the candidate-employer matching application 112 before any personal and professional data is shared through secure messaging. The secure messaging and profile access control module 208 may provide trust-based information exchange between the candidate and employer to build rapport and gauge mutual interest before exchanging personal and professional data. In some cases, the secure messaging and profile access control module 208 may encourage authentic conversations before an interview stage, allowing both employers and candidates to build rapport and assess fit. The secure messaging and profile access control module 208 may also provide permission-based access functionality, audit logging functionality, and revocable access functionality such that candidates may revoke previously granted access to private information at any time.

The employer profile access requests module 210 may provide request submission functionality that allows employers to request access to a connected candidate's private profile. In some cases, the employer profile access requests module 210 may provide approval-based sharing functionality where a candidate must approve an employer's request before any private personal and professional data is shared between the parties. The employer profile access requests module 210 may provide messaging-based access functionality where a candidate may grant full profile access to a particular employer directly within the built-in messaging system. The employer profile access requests module 210 may also provide request history functionality and a notification system for tracking and alerting users regarding profile access requests. In some cases, the employer profile access requests module 210 may provide temporary profile access functionality where employers do not retain continuous access to a candidate's private profile unless explicitly approved each instance by the candidate.

The employer confidentiality module 212 may provide anonymous job postings functionality that allows employers to determine how much job-related information is disclosed before engagement with candidates. In some cases, the employer confidentiality module 212 may provide hidden employer identity functionality and confidential searches functionality for employers working on discreet hiring initiatives. The employer confidentiality module 212 may also provide protected hiring data functionality that allows employers to ensure job opening details are shared with highly matched candidates.

The customizable privacy settings module 214 may provide user-defined preferences functionality that allows candidates and employers to configure privacy controls according to individual preferences. In some cases, the customizable privacy settings module 214 may provide per-field controls that allow users to set visibility options for individual profile fields. The customizable privacy settings module 214 may provide default privacy profiles and settings management functionality for managing privacy configurations. The customizable privacy settings module 214 may include strict access controls designed to prevent unauthorized use of sensitive personal and professional data of both candidates and employers. In some cases, the customizable privacy settings module 214 may provide secure login controls where security is enhanced through the use of multi-factor authentication.

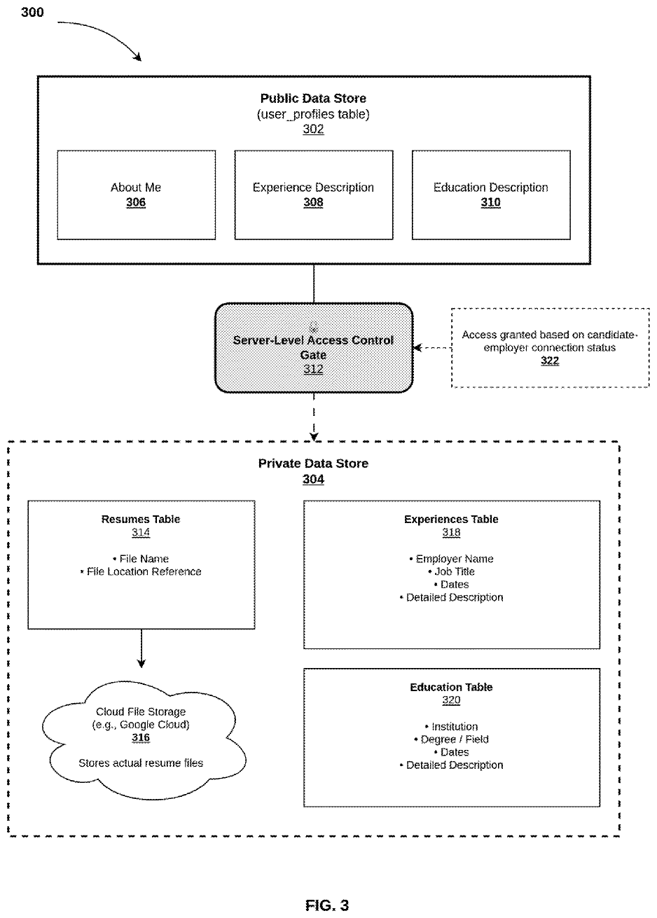

FIG. 3 illustrates a data storage architecture 300 of the candidate-employer matching application 112. Data storage architecture 300 separates public and private candidate data into distinct storage locations to enable access control based on connection status between candidates and employers.

Data storage architecture 300 may include a public data store 302 and a private data store 304. Public data store 302 may store publicly visible candidate information that employers may view without establishing a connection with a candidate. In some cases, public data store 302 may be implemented as a user_profiles table. Public data store 302 may include an About Me field 306, an Experience Description field 308, and an Education Description field 310. In some cases, the user profiles table may also include a phone number field for internal account or administrative purposes. The phone number field may not be publicly disclosed to employers through the candidate-employer matching application 112. About Me field 306 may store a general background description provided by the candidate. Experience Description field 308 may store a high-level summary of the candidate's professional experience. Education Description field 310 may store a high-level summary of the candidate's educational background.

Private data store 304 may store sensitive candidate information that remains hidden until the candidate authorizes disclosure to a specific employer. Private data store 304 may include a Resumes Table 314, an Experiences Table 318, and an Education Table 320. Resumes Table 314 may store a file name and a file location reference for each candidate resume. In some cases, actual resume files may be stored in a cloud file storage 316 that is separate from the database tables. Cloud file storage 316 may be implemented using a cloud storage service such as Google Cloud. Resumes Table 314 may be communicatively coupled to cloud file storage 316 such that Resumes Table 314 stores references to resume files located in cloud file storage 316. Experiences Table 318 may store private detailed experience information for each candidate. Education Table 320 may store private detailed education information for each candidate.

The segregation of public data store 302 and private data store 304 may be implemented through separate database tables or separate database instances that enforce data-level access control. In some cases, database queries for candidate information may be structured to access only public data store 302 by default, with access to private data store 304 requiring an additional authorization check based on candidate-employer connection status 322. The database query logic may include a join condition or subquery that verifies connection status before returning any records from private data store 304. If the connection status check fails, the query may return only public data or may return an empty result set for the private data portion of the request. This data-level enforcement provides a technical security architecture in which private data is not merely hidden by the application layer but is prevented from being returned by the database layer when authorization conditions are not met. In some cases, the separation of public and private data stores may also facilitate different backup, retention, and encryption policies for sensitive private data.

A server-level access control gate 312 may be interposed between public data store 302 and private data store 304. Server-level access control gate 312 may enforce access restrictions at the server level based on a candidate-employer connection status 322. Candidate-employer connection status 322 may indicate whether a connection has been established between a candidate and an employer. Server-level access control gate 312 may block access to private data store 304 at the server level when no connection exists between a candidate and an employer. In some cases, server-level access control gate 312 may reject private data queries when candidate-employer connection status 322 does not authorize access, rather than relying on user interface-level hiding of information.

The candidate-employer matching system 100 may automatically change what an employer can see about a candidate based on candidate-employer connection status 322. When candidate-employer connection status 322 indicates that no connection exists, server-level access control gate 312 may block all access to private data store 304. When candidate-employer connection status 322 indicates that a connection has been established and the candidate has granted access, server-level access control gate 312 may permit the employer to access the contents of private data store 304. When a connection ends between a candidate and an employer, server-level access control gate 312 may automatically revoke access to private data store 304 for that employer.

In some aspects, the server-level access control gate 312 may also enforce access revocation when a candidate withdraws sharing permissions while a connection remains active. For example, a candidate may revoke an employer's access to private profile data through the Per-Employer Access Management controls while the connection between the candidate and the employer remains established. When the candidate revokes sharing permissions, server-level access control gate 312 may immediately stop returning private data in response to queries from that employer, even though the connection has not ended. The connection may remain active such that messaging between the candidate and the employer is still enabled, but the employer's access to private profile data is terminated based on the candidate's updated sharing permissions. This ensures that the candidate maintains control over private data disclosure independently of connection status.

Server-level access control gate 312 may implement query-level enforcement logic that evaluates candidate-employer connection status 322 before processing any request for private data. In some cases, when a query is received for data in private data store 304, server-level access control gate 312 may first retrieve the connection status between the requesting employer and the candidate whose data is being requested. If the connection status indicates that no connection exists or that the candidate has not granted access, server-level access control gate 312 may reject the query and return an access denied response rather than returning the requested data. This server-level enforcement, as described above with respect to data storage architecture 300, prevents unauthorized access through direct database queries, application programming interface calls, or other mechanisms that bypass user interface controls. In some cases, server-level access control gate 312 may log unauthorized access attempts for security auditing purposes.

The candidate-employer matching system 100 may implement security mechanisms to protect candidate and employer data during transmission and storage. In some cases, data transmitted between the candidate-employer matching application 112 and server 116 may be encrypted using transport layer security protocols to prevent interception or tampering during network transmission. Data stored in cloud database 118 and cloud file storage 316 may be encrypted at rest using encryption keys managed by the candidate-employer matching system 100 or by the cloud storage provider. The candidate-employer matching system 100 may implement authentication token handling for application programming interface calls, in which the candidate-employer matching application 112 includes a cryptographically signed authentication token with each request to server 116. Server 116 may validate the authentication token before processing the request and may reject requests with invalid, expired, or missing tokens. In some cases, the candidate-employer matching system 100 may implement rate limiting to prevent unauthorized bulk data access, in which server 116 tracks the number of requests from each user or application instance and rejects requests that exceed a predefined threshold within a time period. The security mechanisms may protect sensitive candidate and employer data from unauthorized access while enabling legitimate system operations.

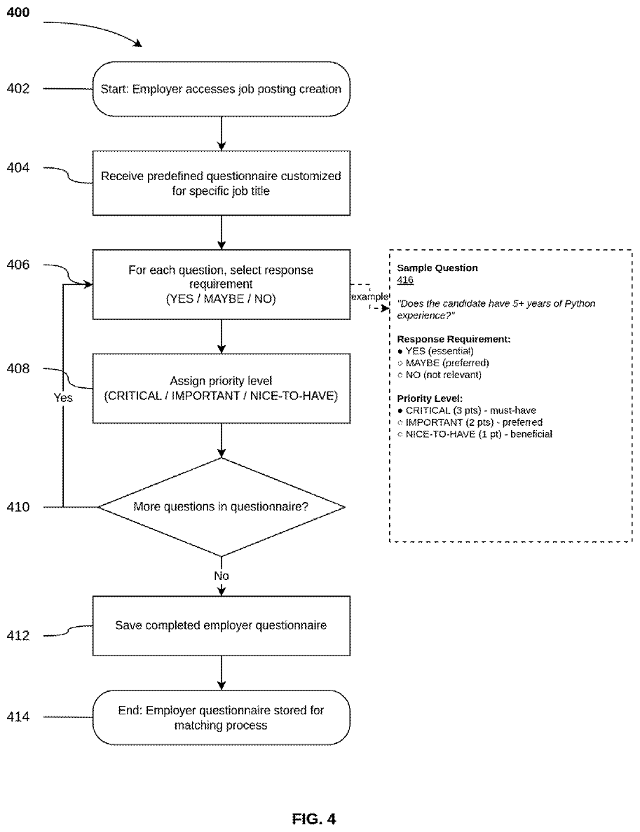

FIG. 4 illustrates a flowchart of a method 400 for configuring an employer questionnaire used in the candidate-employer matching process. The candidate-employer matching system 100 may utilize industry-specific and job title-specific questionnaires developed in collaboration with industry experts and employer partners. In some cases, questionnaires may be customized for each job title to attract and identify suitable candidates. Questionnaires may be continuously refined based on user feedback and enhanced matching techniques to improve precision in identifying candidates whose qualifications align with job requirements.

Method 400 may begin at a step 402, where an employer accesses job posting creation within the candidate-employer matching application 112. At a step 404, the employer may receive a predefined questionnaire customized for a specific job title. The predefined questionnaire may include standardized questions with selectable response options representing qualifications, experience levels, and professional preferences for the role. In some cases, the predefined questionnaire may be designed to ensure relevance to the specific job title and posting.

At a step 406, for each question in the questionnaire, the employer may select a response requirement for each response option. The response requirement may indicate whether a particular response satisfies, partially satisfies, or does not satisfy a requirement for the role. In some cases, the employer may select from the following response requirements: YES, indicating that the response is satisfactory for the role; MAYBE, indicating that the response is preferred but not mandatory for the role; and NO, indicating that the response is not relevant to the role. The response requirement selection process may ensure consistency and clarity when evaluating candidates.

At a step 408, the employer may assign a priority level to the question based on the question's relevance to the employment opportunity. The priority level may determine the relative weight applied to the question during a matching calculation. In some cases, the employer may select from the following priority levels: CRITICAL, worth 3 points, for qualifications that are required for the job opening such as experience level, required skills, or educational background; IMPORTANT, worth 2 points, for qualifications that are strongly preferred but not mandatory for the job opening such as company size preference; and NICE-TO-HAVE, worth 1 point, for qualifications that are beneficial but not required for the job opening such as leadership style. Points may be allocated to each question based on the employer-defined priority level to help quantify the alignment of job candidates during the matching process.

The three-tier priority weighting system using CRITICAL, IMPORTANT, and NICE-TO-HAVE designations with corresponding point values of 3, 2, and 1 may be designed to provide employers with a structured mechanism for expressing the relative importance of different job requirements. In some cases, alternative weighting schemes may be utilized, such as a five-tier system with point values ranging from 1 to 5, a continuous weighting scale allowing employers to assign any numerical weight within a defined range, or a binary weighting system distinguishing only between required and optional criteria. The three-tier system may provide a balance between granularity and simplicity, allowing employers to differentiate among criteria without requiring excessive configuration effort. This approach differs from prior art binary weighting systems that distinguish only between required and non-required criteria, and from prior art continuous weighting approaches that may require employers to assign precise numerical weights without clear guidance on relative values. The defined point values of 3, 2, and 1 may ensure consistent interpretation of priority levels across different employers and job postings.

A decision 410 may determine whether additional questions remain in the questionnaire. If additional questions remain, method 400 may loop back to step 406 for the next question. If no additional questions remain, method 400 may proceed to a step 412, where the employer may save the completed employer questionnaire.

Method 400 may end at a step 414, where the employer questionnaire may be stored for use in the matching process. The stored employer questionnaire may be utilized for comparison purposes during the matching step with job candidates.

A sample question 416 may illustrate an example question with the available response requirement and priority level selections. Sample question 416 may display a question such as “What is the minimum years of relevant experience required?” along with response options such as “Less than 1,” “1-3,” “4-6,” “7-10,” “11-20,” and “More than 20.” For each response option, the employer may select YES, MAYBE, or NO to indicate whether the response satisfies the role requirements. The employer may also select a priority level of CRITICAL, IMPORTANT, or NICE-TO-HAVE to indicate the relative weight of the question in the matching calculation.

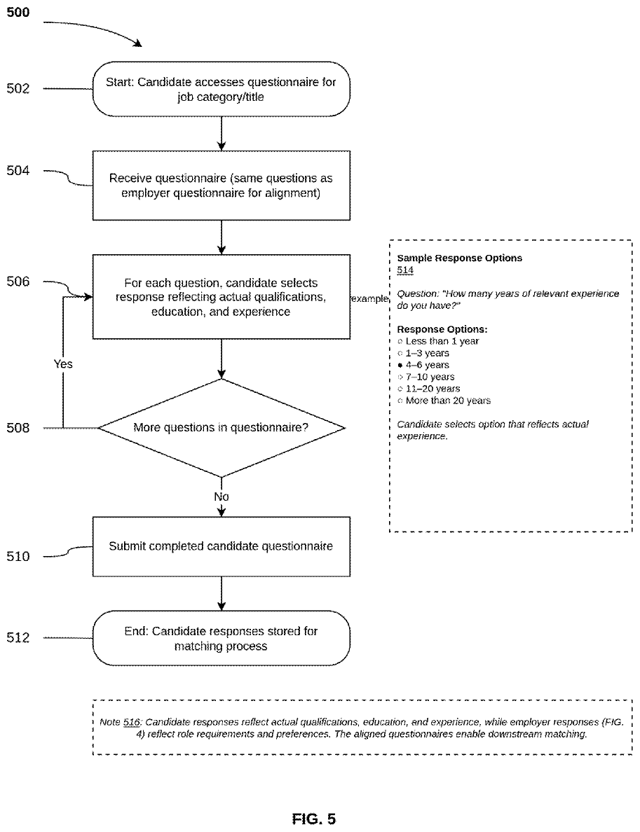

FIG. 5 illustrates a flowchart of a method 500 for completing a candidate questionnaire used in the candidate-employer matching process. The candidate questionnaire may be designed to permit a job candidate to input personal and professional data in a secure and confidential manner.

Method 500 may begin at a step 502, where a candidate accesses a questionnaire for a selected job category or job title. In some cases, the candidate may select a profession and job title before beginning a new questionnaire. The candidate-employer matching application 112 may present questionnaires that are tailored to the selected job category or job title.

At a step 504, the candidate may receive the questionnaire containing questions aligned with the corresponding employer questionnaire. The candidate questionnaire and the employer questionnaire may have many of the same questions to ensure alignment in evaluation criteria. While the questions may remain the same between the candidate questionnaire and the employer questionnaire, the candidate's responses reflect the candidate's actual qualifications, education, and experience rather than employer expectations or role requirements.

At a step 506, for each question in the questionnaire, the candidate may select a response that reflects the candidate's actual qualifications, education, and experience. Sample response options 514 may illustrate example selections available to the candidate. For a question regarding years of experience, sample response options 514 may include selections such as “Less than 1 year,” “1-3 years,” “4-6 years,” “7-10 years,” “11-20 years,” and “More than 20 years.” The candidate may select the response option that accurately describes the candidate's qualifications for each question.

A decision 508 may determine whether additional questions remain in the questionnaire. If additional questions remain, method 500 may loop back to step 506 for the next question. If no additional questions remain, method 500 may proceed to a step 510, where the candidate may submit the completed candidate questionnaire.

Method 500 may end at a step 512, where the candidate responses may be stored for use in the matching process. The stored candidate responses may be utilized for comparison against employer-defined criteria during the matching process.

In some aspects, certain candidate questionnaire questions may allow a candidate to select multiple answers rather than only one answer. For example, a question regarding areas of professional experience or relevant skills may permit the candidate to select multiple response options that accurately describe the candidate's qualifications. The employer may continue to define the response evaluations for the question using the evaluation designations (YES, MAYBE, NO) and priority weights as described with respect to method 400 of FIG. 4. The candidate-employer matching system 100 may evaluate the candidate's selected answers against the employer-defined response evaluations to determine whether the candidate response results in an exact match, partial match, or no match. In some cases, the system may determine the match type based on the highest-scoring response option selected by the candidate. In other cases, the system may determine the match type based on a combination or aggregate of the selected response options. The multi-select capability may allow candidates to more accurately represent qualifications that span multiple categories or areas of experience without being limited to a single response option.

An annotation note 516 may indicate that candidate responses reflect actual qualifications, education, and experience, while employer responses reflect role requirements and preferences. Annotation note 516 may further indicate that the aligned questionnaires enable downstream matching between candidates and employers. The alignment between the candidate questionnaire and the employer questionnaire may be implemented through a shared question definition structure in which both questionnaires reference the same underlying question identifiers and response option sets. In some cases, the candidate-employer matching system 100 may maintain a question library containing standardized questions for each job title or role category, and both the employer questionnaire and the candidate questionnaire may be generated from this shared question library to ensure question parity. The data structure linking employer response requirements to candidate response options may include a mapping that associates each response option identifier with the employer's evaluation designation for that option. This aligned questionnaire approach differs from prior art systems that use separate unstructured inputs, such as resumes and job descriptions, which require text-based parsing and may produce inconsistent evaluations due to variations in terminology and formatting.

In some aspects, the candidate-employer matching system 100 may support a two-stage questionnaire matching process. In a first stage, the system may use a generic or baseline set of questions to generate an initial candidate-job match. The baseline questionnaire may include standardized questions applicable across multiple job titles or role categories, such as questions regarding general experience level, industry background, or professional preferences. In a second stage, the employer may define, customize, or select an additional set of job-specific questions that are presented to candidates for that particular job posting. The secondary employer-defined questionnaire may include questions tailored to the specific requirements, qualifications, or attributes of the particular role. The candidate-employer matching system 100 may use the secondary employer-defined questionnaire to refine the match score calculated from the first stage, confirm candidate fit, prioritize candidates within a pool of initial matches, or determine whether additional engagement controls such as Express Interest or Share Resume buttons should be enabled. In some cases, the match percentage may be calculated based on a combination of responses from both the first-stage baseline questionnaire and the second-stage employer-defined questionnaire. In some cases, the employer may assign different priority weights to questions in the first-stage and second-stage questionnaires.

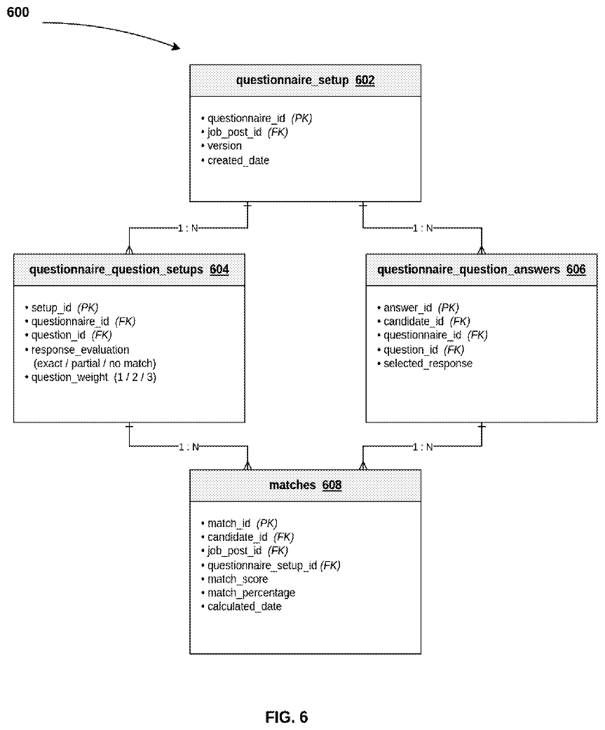

FIG. 6 illustrates an entity-relationship diagram of a questionnaire version tracking data model 600. Questionnaire version tracking data model 600 may include four related tables that track each version of an employer's job-post questionnaire, the employer's per-question setup, the candidate's answers, and the resulting matches.

A questionnairel_setup table 602 may store each instance of an employer's job-post questionnaire. Questionnaire\_setup table 602 may include a questionnaire\_id field serving as a primary key, a job\ post\_id field serving as a foreign key, a version field, and a created\_date field. The questionnaire\_id field may uniquely identify each questionnaire instance. The job\_post\_id field may associate the questionnaire with a corresponding job posting. The version field may track different versions of the questionnaire for the same job posting. The created\_date field may record when the questionnaire instance was created.

A questionnaire\_question\_setups table 604 may store how the employer answers each question in the questionnaire. Questionnaire\_question\_setups table 604 may include a setup\_id field serving as a primary key, a questionnaire\_id field serving as a foreign key to questionnaire\_setup table 602, a question\_id field serving as a foreign key, a response\_evaluation field, and a question\_weight field. The response\_evaluation field may store the employer's evaluation designation for each response option, such as exact match, partial match, or no match. The question\_weight field may store the employer-assigned priority weight for the question, such as 1 for NICE-TO-HAVE, 2 for IMPORTANT, or 3 for CRITICAL.

A questionnaire\_question\_answers table 606 may store the candidate answers to questionnaires. Questionnaire\_question\_answers table 606 may include an answer\_id field serving as a primary key, a candidate\_id field serving as a foreign key, a questionnaire\_id field serving as a foreign key to questionnaire\_setup table 602, a question\_id field serving as a foreign key, and a selected\_response field. The selected\_response field may store the response option selected by the candidate for each question.

A matches table 608 may store the candidate's match results to the job and questionnaire setup. Matches table 608 may include a match\ id field serving as a primary key, a candidate\_id field serving as a foreign key, a job\ post\_id field serving as a foreign key, a questionnaire\_setup\_id field serving as a foreign key to questionnaire\_setup table 602, a match\ score field, a match\ percentage field, and a calculated\_date field. The match\_score field may store the total weighted score calculated for the candidate. The match\ percentage field may store the percentage value representing the degree of alignment between the candidate and the job requirements. The calculated\_date field may record when the match calculation was performed.

Questionnaire version tracking data model 600 may define relationships between the tables to preserve questionnaire history. Questionnaire\_setup table 602 may have a one-to-many relationship with questionnaire\_question\_setups table 604 such that each questionnaire instance may be associated with multiple question setup records. Questionnaire\_setup table 602 may have a one-to-many relationship with questionnaire\_question\_answers table 606 such that each questionnaire instance may be associated with multiple candidate answer records. Both questionnaire\_question\_setups table 604 and questionnaire\_question\_answers table 606 may have one-to-many relationships with matches table 608 such that match scores may be computed from the per-question employer setups in questionnaire\_question\_setups table 604 and the corresponding candidate answers in questionnaire\_question\_answers table 606. The relationships between the tables may allow the candidate-employer matching system 100 to maintain a history of questionnaire versions and recalculate match scores when questionnaire configurations change.

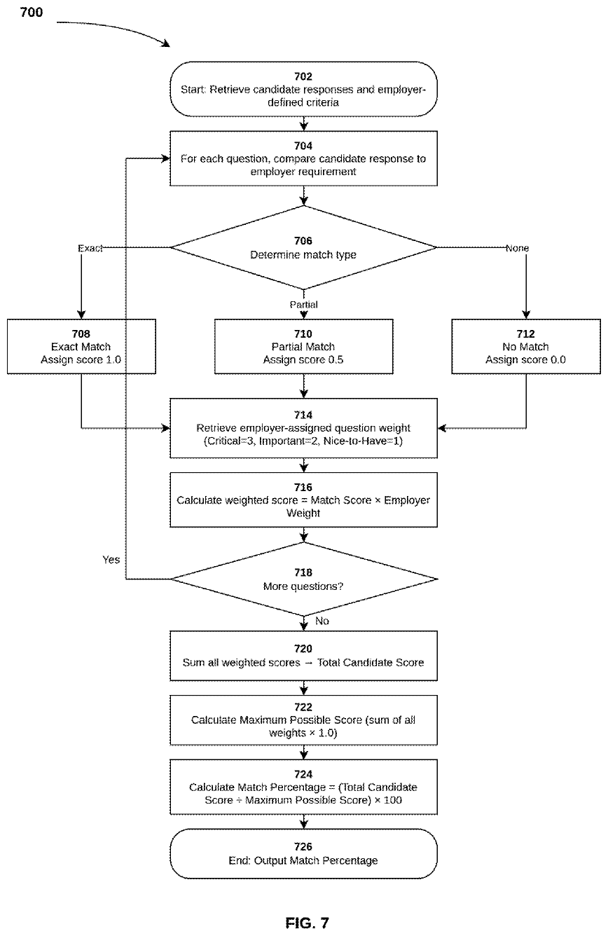

FIG. 7 illustrates a flowchart of a method 700 for calculating a candidate match percentage based on candidate-employer questionnaire responses. Method 700 may utilize the stored candidate responses and employer-defined criteria to compute a quantitative measure of alignment between a candidate and a job posting.

Method 700 may begin at a step 702, where candidate responses and employer-defined criteria are retrieved. The candidate responses may be retrieved from questionnaire\_question\_answers table 606, and the employer-defined criteria may be retrieved from questionnaire\_question\_setups table 604. The retrieved data may include the candidate's selected response for each question and the employer's response evaluation and question weight for each question.

At a step 704, for each question in the questionnaire, the candidate's response may be compared to the employer's requirement. The comparison may evaluate whether the candidate's selected response aligns with the employer's evaluation designation for that response option.

A decision 706 may determine a match type for the question based on the comparison performed at step 704. Decision 706 may classify the comparison result into one of three categories: exact match, partial match, or no match.

If the candidate's response is an exact match with the employer's criteria, method 700 may proceed to a step 708, where a match score of 1.0 may be assigned to the question. An exact match may occur when the candidate's response fully meets the employer's criteria for the question.

If the candidate's response is a partial match with the employer's criteria, method 700 may proceed to a step 710, where a match score of 0.5 may be assigned to the question. A partial match may occur when the candidate's response somewhat aligns with the employer's criteria but does not fully meet the employer's criteria.

If the candidate's response does not match the employer's criteria, method 700 may proceed to a step 712, where a match score of 0.0 may be assigned to the question. A no match designation may occur when the candidate's response does not meet the employer's criteria for the question.

The three branches from decision 706 may converge at a step 714, where the employer-assigned question weight may be retrieved. The question weight may correspond to the priority level assigned by the employer during questionnaire configuration, such as 3 for CRITICAL, 2 for IMPORTANT, or 1 for NICE-TO-HAVE.

At a step 716, a weighted score may be calculated for the question. The weighted score may be computed as the product of the match score and the employer-assigned question weight. For example, if a question receives a match score of 1.0 and has a question weight of 3, the weighted score for that question may be 1.0× 3=3.0.

A decision 718 may determine whether additional questions remain in the questionnaire. If additional questions remain, method 700 may loop back to step 704 to process the next question. If no additional questions remain, method 700 may proceed to a step 720.

At step 720, the weighted scores for all questions may be summed to produce a Total Candidate Score. The Total Candidate Score may represent the aggregate weighted performance of the candidate across all questions in the questionnaire.

At a step 722, a Maximum Possible Score may be calculated. The Maximum Possible Score may be computed as the sum of all employer-assigned question weights multiplied by 1.0, representing the score a candidate would achieve if the candidate received an exact match on every question.

At a step 724, a Match Percentage may be calculated. The Match Percentage may be computed by dividing the Total Candidate Score by the Maximum Possible Score and multiplying by 100, expressed as:

$$Match Percentage = ( \frac{Total Candidate Score}{Maximum Possible Score} ) \times 100$$

Method 700 may end at a step 726, where the Match Percentage may be output for use by the candidate-employer matching application 112. The output Match Percentage may be stored in matches table 608 and may be utilized by the candidate-employer matching system 100 for threshold-based engagement controls and display to users.

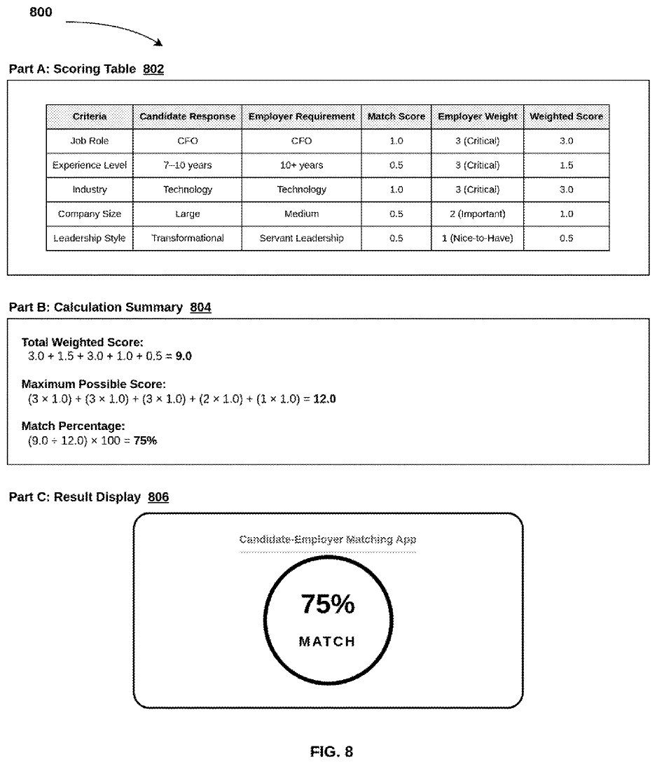

FIG. 8 illustrates a match percentage calculation example 800 demonstrating the candidate match percentage calculation performed by method 700 of FIG. 7. Match percentage calculation example 800 provides a concrete worked example of the matching algorithm using sample criteria and responses.

Part A of FIG. 8 shows a scoring table 802 that lists a plurality of criteria along with corresponding candidate responses, employer requirements, match scores, employer-assigned weights, and resulting weighted scores. Scoring table 802 may include the following criteria:

| | Candidate | Employer | Match | | Weighted |
|---|---|---|---|---|---|
| Criterion | Response | Requirement | Score | Weight | Score |
| Job Role | CFO | CFO | 1.0 | 3 | 3.0 |
| Experience | 7-10 Years | 10+ Years | 0.5 | 3 | 1.5 |
| Level | | | | | |
| Industry | Technology | Technology | 1.0 | 3 | 3.0 |
| Company | Large | Medium | 0.5 | 2 | 1.0 |
| Size | | | | | |
| Leadership | Trans- | Servant | 0.5 | 1 | 0.5 |
| Style | formational | Leadership | | | |

For the Job Role criterion, the candidate response of “CFO” may match the employer requirement of “CFO” as an exact match, resulting in a match score of 1.0. The employer may assign a weight of 3 (CRITICAL) to the Job Role criterion, producing a weighted score of 1.0×3=3.0.

For the Experience Level criterion, the candidate response of “7-10 Years” may partially align with the employer requirement of “10+ Years,” resulting in a match score of 0.5. The employer may assign a weight of 3 (CRITICAL) to the Experience Level criterion, producing a weighted score of 0.5×3=1.5.

For the Industry criterion, the candidate response of “Technology” may match the employer requirement of “Technology” as an exact match, resulting in a match score of 1.0. The employer may assign a weight of 3 (CRITICAL) to the Industry criterion, producing a weighted score of 1.0× 3=3.0.

For the Company Size criterion, the candidate response of “Large” may partially align with the employer requirement of “Medium,” resulting in a match score of 0.5. The employer may assign a weight of 2 (IMPORTANT) to the Company Size criterion, producing a weighted score of 0.5×2=1.0.

For the Leadership Style criterion, the candidate response of “Transformational” may partially align with the employer requirement of “Servant Leadership,” resulting in a match score of 0.5. The employer may assign a weight of 1 (NICE-TO-HAVE) to the Leadership Style criterion, producing a weighted score of 0.5×1=0.5.

Part B of FIG. 8 shows a calculation summary 804 that computes the Total Weighted Score, Maximum Possible Score, and Match Percentage. Calculation summary 804 may compute the Total Weighted Score by summing the weighted scores from scoring table 802:

Total Weighted Score=3.0+1.5+3.0+1.0+0.5=9.0

Calculation summary 804 may compute the Maximum Possible Score by summing all employer-assigned weights multiplied by 1.0, representing the score achievable if the candidate received an exact match on every criterion:

Maximum Possible Score=(3×1.0)+(3×1.0)+(3×1.0)+(2×1.0)+(1×1.0)=12.0

Calculation summary 804 may compute the Match Percentage by dividing the Total Weighted Score by the Maximum Possible Score and multiplying by 100:

$$Match Percentage = ( \frac{9.0}{12.0} ) \times 100 = 75 \%$$

Part C of FIG. 8 shows a result display 806 that depicts how the resulting Match Percentage may be presented to a user within the user interface of candidate-employer matching application 112. Result display 806 may present the Match Percentage as a “75% MATCH” indicator, providing a clear visual representation of the degree of alignment between the candidate and the job requirements.

The candidate-employer matching system 100 may utilize the match percentage calculation to generate a curated set of high-fit candidates for employers rather than presenting employers with a large volume of candidates that may not align with job requirements. By computing match percentages based on structured questionnaire responses and employer-defined weights, the candidate-employer matching system 100 may prioritize presenting candidates whose qualifications align with employer criteria.

The candidate-employer matching application 112 may provide an intuitive interface platform designed for clarity and ease of use. The interface may allow users to build profiles, review match percentages, and initiate conversations with matched candidates or employers. Result display 806 may present match percentage information in a format that allows users to quickly assess alignment between candidates and job postings.

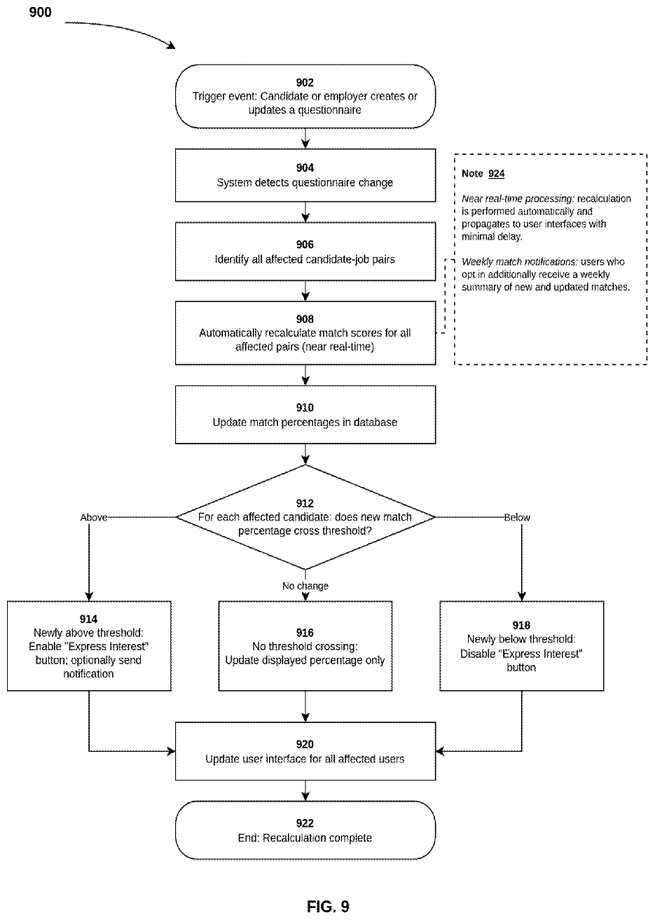

FIG. 9 illustrates a flowchart of a method 900 for near real-time match recalculation in the candidate-employer matching application 112. Method 900 may enable the candidate-employer matching system 100 to automatically recalculate match scores when a candidate or employer creates or updates a questionnaire.

Method 900 may begin at a step 902 with a trigger event in which a candidate or employer creates or updates a questionnaire. The trigger event may occur when an employer modifies response requirements or priority levels for a job posting questionnaire, or when a candidate submits new responses or updates existing responses to a questionnaire.

At a step 904, the candidate-employer matching system 100 may detect the questionnaire change. The detection may occur in response to the trigger event at step 902 and may initiate the recalculation process.

At a step 906, the candidate-employer matching system 100 may identify all affected candidate-job pairs. The affected candidate-job pairs may include all combinations of candidates and job postings where the questionnaire change may impact the calculated match percentage. In some cases, when an employer updates a job posting questionnaire, the affected pairs may include all candidates who have completed the corresponding candidate questionnaire. In some cases, when a candidate updates questionnaire responses, the affected pairs may include all job postings associated with the questionnaire.

At a step 908, the candidate-employer matching system 100 may automatically recalculate match scores for all affected candidate-job pairs in near real-time. The recalculation may utilize method 700 of FIG. 7 to compute updated match percentages based on the modified questionnaire data. The near real-time recalculation may provide updated match information with minimal delay following the questionnaire change.

In some instances, the candidate-employer matching system 100 may implement a scalability architecture to handle large numbers of candidates, employers, and job postings. In some cases, the matching algorithm may be distributed across multiple server instances to enable parallel processing of match calculations. Server 116 may comprise a cluster of server instances behind a load balancer that distributes incoming requests and recalculation workloads across available server resources. The candidate-employer matching system 100 may implement database sharding or partitioning to distribute candidate and employer data across multiple database instances, enabling horizontal scaling as the number of users increases. In some cases, questionnaire data and match results may be partitioned by job category, geographic region, or employer identifier to optimize query performance and enable independent scaling of different data partitions. The candidate-employer matching system 100 may utilize message queues to distribute recalculation workloads across multiple worker processes, enabling the system to handle spikes in recalculation demand when multiple employers simultaneously update questionnaire configurations. The scalability architecture may enable the candidate-employer matching system 100 to maintain near real-time match recalculation performance as the number of candidates, employers, and job postings increases.

At a step 910, the updated match percentages may be written to the database. The updated match percentages may be stored in matches table 608 for retrieval and display to users.

A decision 912 may determine, for each affected candidate, whether the new match percentage crosses a threshold. Decision 912 may evaluate whether the recalculated match percentage has transitioned from below the threshold to at or above the threshold, has remained in the same relationship to the threshold, or has transitioned from at or above the threshold to below the threshold.

If the match percentage is newly above the threshold, method 900 may proceed to a step 914. At step 914, the candidate-employer matching system 100 may enable an “Express Interest” button for the affected candidate-job pair. In some cases, step 914 may also send a threshold-crossing notification to the candidate to inform the candidate that the match percentage now meets the engagement threshold.

If there is no threshold crossing, method 900 may proceed to a step 916. At step 916, the candidate-employer matching system 100 may update the displayed percentage without changing the state of engagement controls. The updated match percentage may be reflected in the user interface while the “Express Interest” button may remain in the same enabled or disabled state.

If the match percentage is newly below the threshold, method 900 may proceed to a step 918. At step 918, the candidate-employer matching system 100 may disable the “Express Interest” button for the affected candidate-job pair. The disabled state may prevent the candidate from expressing interest in the job posting until the match percentage meets the threshold.

The three branches from decision 912 may converge at a step 920, where the candidate-employer matching system 100 may update the user interface for all affected users. Step 920 may refresh the displayed match percentages and engagement control states for candidates and employers associated with the affected candidate-job pairs.

Method 900 may end at a step 922, where the recalculation is complete. The candidate-employer matching system 100 may return to monitoring for subsequent questionnaire changes that may trigger additional recalculations.

An annotation note 924 may indicate that recalculation is performed in near real-time with minimal delay to user interfaces. Annotation note 924 may further indicate that users who opt in may receive weekly match notification summaries. The weekly match notification may provide candidates and employers with a summary of match percentage changes and new matches that have occurred during the preceding week. In some cases, the candidate-employer matching system 100 may send the weekly match notification to candidates and employers who have enabled the notification preference in the customizable privacy settings module 214.

The near real-time match recalculation may be implemented through an event-driven architecture in which questionnaire creation or update events trigger a recalculation process. In some cases, when an employer updates a job posting questionnaire, the candidate-employer matching system 100 may identify all affected candidate-job pairs by querying questionnaire_question_answers table 606 to retrieve all candidates who have completed the corresponding candidate questionnaire. The recalculation process may be executed as a batch operation that processes multiple candidate-job pairs in a single database transaction to ensure consistency. In some cases, the candidate-employer matching system 100 may utilize database indexing on questionnaire identifiers and candidate identifiers to efficiently identify affected pairs without requiring a full table scan. The near real-time processing may be achieved through asynchronous job queues that process recalculation requests with minimal latency while avoiding blocking of user interface operations. In some cases, the candidate-employer matching system 100 may prioritize recalculation of candidate-job pairs where the match percentage is near the matching percentage threshold, as these pairs are most likely to experience a threshold-crossing event that affects engagement button state.

The candidate-employer matching system 100 may implement database transaction handling mechanisms to maintain data consistency during concurrent questionnaire updates. In some cases, when multiple employers are simultaneously modifying questionnaire configurations or when multiple candidates are submitting questionnaire responses, the system may utilize database locking mechanisms to prevent conflicting updates from corrupting data integrity. The candidate-employer matching system 100 may implement optimistic locking, in which the system checks whether data has been modified by another transaction before committing changes, or pessimistic locking, in which the system acquires exclusive locks on data records during modification. In some cases, the system may utilize transaction isolation levels to control how concurrent transactions interact with shared data. If a transaction fails due to a conflict or system error, the candidate-employer matching system 100 may execute transaction rollback procedures to restore the database to a consistent state prior to the failed transaction. The database transaction handling mechanisms may ensure that match percentage calculations are based on consistent questionnaire data even when multiple users are modifying data concurrently.

The candidate-employer matching system 100 may implement a caching architecture to optimize performance and reduce database load during match percentage retrieval and display. In some cases, calculated match percentages may be cached in a distributed cache or in-memory data store to enable rapid retrieval without requiring recalculation for each user interface request. The caching architecture may implement cache invalidation logic that automatically invalidates cached match percentages when underlying questionnaire data changes. In some cases, cache invalidation may be triggered by events such as an employer modifying questionnaire response requirements or priority weights, a candidate updating questionnaire responses, or a change in connection status between a candidate and an employer. The candidate-employer matching system 100 may implement cache expiration policies that balance cache freshness with performance requirements, such as time-based expiration or event-driven invalidation. In some cases, the system may utilize cache warming techniques to pre-populate cached match percentages for frequently accessed candidate-job pairs. The caching architecture may reduce latency for user interface operations while ensuring that displayed match percentages reflect current questionnaire configurations.

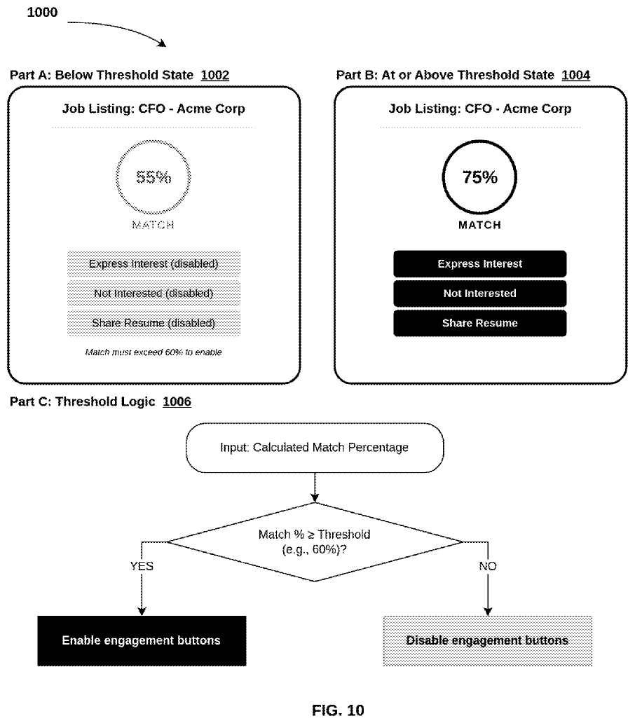

FIG. 10 illustrates a threshold-based engagement control diagram 1000 showing the dynamic behavior of engagement controls based on a match threshold. Threshold-based engagement control diagram 1000 depicts how the candidate-employer matching application 112 may regulate user interface elements based on computed match percentages.

Part A of FIG. 10 shows a below-threshold state 1002 in which a job listing card displays a match percentage below the threshold. In below-threshold state 1002, the match percentage may be displayed as a value such as 55%, which falls below a matching percentage threshold. The candidate-employer matching application 112 may automatically disable or gray out engagement buttons when the candidate's match score is below the matching percentage threshold. In some cases, the engagement buttons may be hidden from view when the match percentage is below the threshold. In below-threshold state 1002, an “Express Interest” button, a “Not Interested” button, and a “Share Resume” button may be hidden from view or may be displayed as grayed out and disabled. When displayed in a disabled state, the engagement buttons may be visually distinguished from enabled buttons through a grayed-out appearance that indicates the buttons are not selectable. In some cases, below-threshold state 1002 may display a tooltip message when a candidate hovers over or interacts with a disabled button. The tooltip message may explain that the match percentage is below the threshold and may indicate the threshold value that the candidate's match percentage is required to meet or exceed to enable the engagement buttons. For example, the tooltip message may indicate that the match percentage is required to exceed 60% to enable the buttons.

Part B of FIG. 10 shows an at-or-above-threshold state 1004 in which a job listing card displays a match percentage at or above the threshold. In at-or-above-threshold state 1004, the match percentage may be displayed as a value such as 75%, which meets or exceeds the matching percentage threshold. When the candidate's match score meets the matching percentage threshold, the candidate-employer matching application 112 may display and enable the engagement buttons. In at-or-above-threshold state 1004, the “Express Interest” button, the “Not Interested” button, and the “Share Resume” button may become visible and/or enabled. The enabled engagement buttons may be visually distinguished from disabled buttons through an active appearance that indicates the buttons are selectable. The candidate may interact with the enabled engagement buttons to express interest in the job posting, indicate lack of interest, or share a resume with the employer.

Part C of FIG. 10 shows a threshold logic 1006 as a decision diagram that determines button visibility and enablement based on the calculated match percentage. Threshold logic 1006 may receive the calculated match percentage as an input and compare the match percentage to the matching percentage threshold. If the match percentage is greater than or equal to the matching percentage threshold, threshold logic 1006 may output a determination to show and enable the engagement buttons. If the match percentage is less than the matching percentage threshold, threshold logic 1006 may output a determination to hide or disable the engagement buttons.

The matching percentage threshold may be configured at various levels. In some cases, the matching percentage threshold may be at least around 60%. In some cases, the matching percentage threshold may be at least around 70%. In some cases, the matching percentage threshold may be at least around 80%. In some cases, the matching percentage threshold may be at least around 90%. The candidate-employer matching application 112 may apply the matching percentage threshold to determine whether engagement buttons are visible and/or enabled for a particular candidate-job pair.

The dynamic button state behavior depicted in threshold-based engagement control diagram 1000 provides a technical implementation that transforms computed match scores into concrete user interface control. By automatically hiding or disabling engagement buttons when match percentages fall below the threshold and showing or enabling engagement buttons when match percentages meet or exceed the threshold, the candidate-employer matching application 112 may regulate engagement between candidates and employers based on structured compatibility data. The threshold-based engagement controls may help ensure that engagement between candidates and employers occurs when a level of compatibility exists between the candidate's qualifications and the employer's defined requirements.

The dynamic button state behavior may be implemented through a user interface state machine that monitors match percentage values and triggers state transitions when the match percentage crosses the matching percentage threshold. In some cases, the candidate-employer matching application 112 may maintain a button state variable for each candidate-job pair that is updated whenever the match percentage changes. When the match percentage transitions from below the threshold to at or above the threshold, the state machine may transition the button state from hidden or disabled to visible and enabled and may trigger a visual update to the user interface. The tooltip displayed when a candidate interacts with a disabled button may be implemented as a hover event handler that retrieves the current match percentage and threshold value and generates a message explaining the threshold requirement. In some cases, alternative engagement controls beyond the Express Interest button may also be gated by the matching percentage threshold, such as controls for scheduling interviews, requesting additional information, or initiating video introductions. The threshold-based gating of engagement controls provides a technical mechanism that transforms computed compatibility scores into concrete restrictions on user interface interactions.

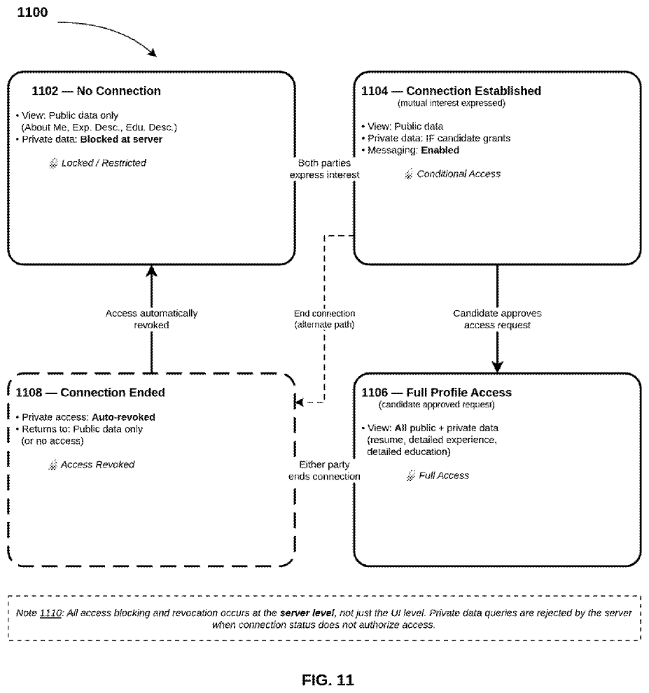

FIG. 11 illustrates a connection lifecycle and access control diagram 1100 showing how access controls change dynamically based on a connection status between a candidate and an employer. Connection lifecycle and access control diagram 1100 depicts four states arranged in a lifecycle cycle, with transitions between states that determine what profile data an employer may access.

A no connection state 1102 represents a default state in which an employer may view public profile data associated with a candidate. Public profile data may include information such as About Me, Experience Description, and Education Description stored in public data store 302 as described with respect to FIG. 3. In no connection state 1102, private profile data may be blocked at the server level. Server 116 may reject queries for private profile data when no connection exists between the candidate and the employer. No connection state 1102 may display an access indicator such as “Locked/Restricted” to indicate that private data access is not authorized.

A connection established state 1104 represents a state in which both the candidate and the employer have expressed mutual interest. In connection established state 1104, the employer may view public profile data, and private profile data may be accessible if the candidate grants permission. Connection established state 1104 may enable messaging between the candidate and the employer through the secure messaging and profile access control module 208. Connection established state 1104 may display an access indicator such as “Conditional Access” to indicate that private data access depends on candidate authorization.

A full profile access state 1106 represents a state in which the candidate has approved an employer's access request. In full profile access state 1106, the employer may access all public and private profile data associated with the candidate. Private profile data accessible in full profile access state 1106 may include resume data stored in Resumes Table 314, detailed experience information stored in Experiences Table 318, and detailed education information stored in Education Table 320. Full profile access state 1106 may display an access indicator such as “Full Access” to indicate that the employer has authorization to view all profile data.

A connection ended state 1108 represents a state in which either the candidate or the employer has ended the connection. In connection ended state 1108, the candidate-employer matching system 100 may automatically revoke all previously granted private profile access, as described above with respect to server-level access control gate 312 of FIG. 3. The employer's access may return to public data in connection ended state 1108. Connection ended state 1108 may display an access indicator such as “Access Revoked” to indicate that private data access has been terminated.

Connection lifecycle and access control diagram 1100 may depict transitions between the four states. A transition from no connection state 1102 to connection established state 1104 may occur when both the candidate and the employer express interest. A transition from connection established state 1104 to full profile access state 1106 may occur when the candidate approves an employer's access request. A transition from full profile access state 1106 or connection established state 1104 to connection ended state 1108 may occur when either the candidate or the employer ends the connection. A transition from connection ended state 1108 to no connection state 1102 may occur when access is automatically revoked.

A server-level access enforcement note 1110 may indicate that all access blocking and revocation occurs at the server level, not at the user interface level. Server-level access enforcement note 1110 may further indicate that private data queries are rejected by server 116 when connection status does not authorize access. This server-level enforcement architecture, as described in detail with respect to server-level access control gate 312 of FIG. 3, provides a technical security mechanism that prevents unauthorized access to private profile data through direct data queries or application programming interface calls that bypass user interface controls.

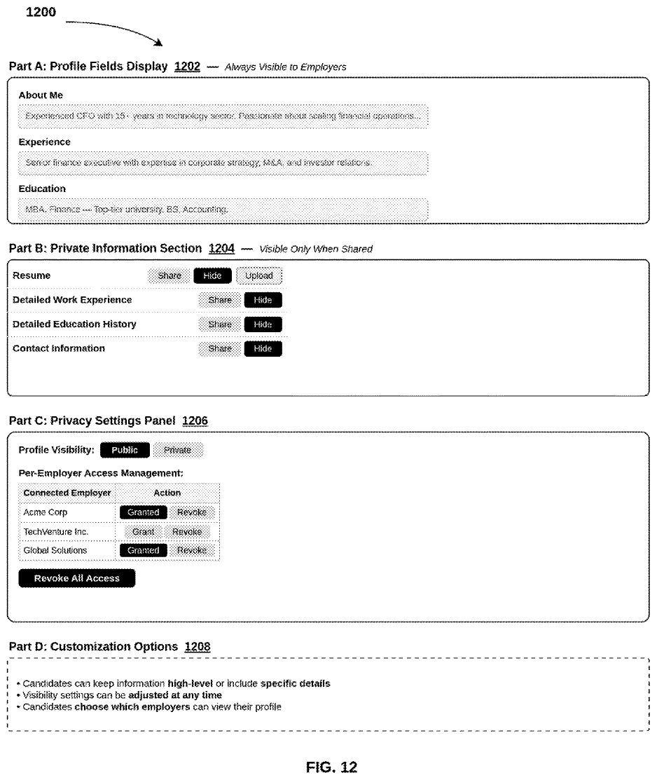

FIG. 12 illustrates a candidate profile visibility control interface 1200. Candidate profile visibility control interface 1200 may provide user interface elements that allow candidates to manage the visibility of profile information and control employer access to personal and professional data.

Part A of FIG. 12 shows a profile fields display 1202 containing at least three candidate profile text fields that are visible to employers. Profile fields display 1202 may include an About Me field, an Experience field, and an Education field. These fields may correspond to the publicly visible information stored in public data store 302 as described with respect to FIG. 3. The About Me field, the Experience field, and the Education field may be labeled as “Always Visible to Employers” to indicate that employers may view the contents of profile fields display 1202 without establishing a connection with the candidate. Profile fields display 1202 may display high-level candidate information that provides employers with general background information about the candidate.

Part B of FIG. 12 shows a private information section 1204 containing private data elements that remain hidden until the candidate authorizes disclosure. Private information section 1204 may include a Resume element, a Detailed Work Experience element, a Detailed Education History element, and a Contact Information element. Each private data element in private information section 1204 may include a Share/Hide toggle that allows the candidate to control visibility of the corresponding data element. Private information section 1204 may be labeled as “Visible Only When Shared” to indicate that employers may view the contents of private information section 1204 when the candidate grants access. In some cases, private information section 1204 may include a Resume Upload button that allows the candidate to upload resume files for storage in cloud file storage 316.

Part C of FIG. 12 shows a privacy settings panel 1206 that provides controls for managing profile visibility and per-employer access. Privacy settings panel 1206 may include a Profile Visibility toggle that allows the candidate to designate the candidate's profile as Public or Private. When the Profile Visibility toggle is set to Private, the candidate's profile may remain hidden until the candidate expressly chooses to share the profile publicly or to particular employers.

Privacy settings panel 1206 may include a Per-Employer Access Management table that lists connected employers. The Per-Employer Access Management table may display employer names such as “Acme Corp,” “Tech Venture Inc.,” and “Global Solutions” along with individual Grant Access and Revoke Access options for each listed employer. The candidate may select Grant Access to authorize a particular employer to view private profile data, or the candidate may select Revoke Access to terminate a particular employer's access to private profile data. In some cases, the candidate may revoke a particular employer's access to personal and professional data or to the candidate's profile at any given time through the Per-Employer Access Management table. Privacy settings panel 1206 may also include a “Revoke All Access” button that allows the candidate to terminate all previously granted private profile access with a single action.

Employers may request access to a connected candidate's private profile through the employer profile access requests module 210. In some cases, a candidate may approve an employer's request before any private personal and professional data is shared between the parties. The candidate may grant full profile access to a particular employer directly within the built-in messaging system provided by the secure messaging and profile access control module 208. In some cases, employers do not retain continuous access to a candidate's private profile unless explicitly approved each instance by the candidate.

Part D of FIG. 12 shows customization options 1208 that indicate the flexibility available to candidates when configuring profile visibility. Customization options 1208 may indicate that candidates may designate certain personal and professional data as high-level or include additional details depending on set preferences. Customization options 1208 may further indicate that candidates may adjust visibility settings at any time and may choose which employers may view the candidate's profile. The candidate profile visibility control interface 1200 may allow candidates to maintain control over personal and professional data throughout the matching and engagement process.

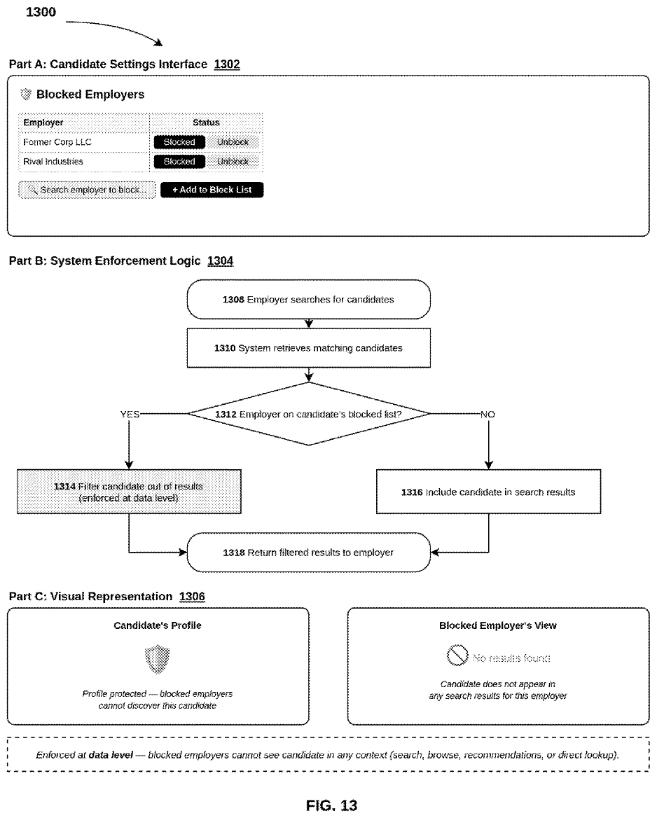

In some aspects, the candidate-employer matching system 100 may include an optional employer blocking feature that may be implemented in some embodiments. For example, FIG. 13 illustrates an employer blocking/access control diagram 1300 depicting a candidate-controlled mechanism for blocking specific employers from discovering or accessing a candidate's profile. Employer blocking/access control diagram 1300 may allow candidates to designate specific employers who are prevented from viewing the candidate's profile, with the candidate-employer matching system 100 enforcing the blocking at the data level by filtering blocked employers out of all search results involving the candidate.

Part A of FIG. 13 shows a candidate settings interface 1302 presenting a Blocked Employers panel. The Blocked Employers panel may list each blocked employer along with a current Blocked status and an Unblock control for each listed employer. In some cases, the Blocked Employers panel may display employer names such as “Former Corp LLC” and “Rival Industries” with corresponding Blocked status indicators. The candidate settings interface 1302 may include a search field and an “Add to Block List” button that allow the candidate to search for and add additional employers to the candidate's block list. The candidate may select the Unblock control for a particular employer to remove the employer from the block list and restore the employer's ability to discover the candidate's profile.

Part B of FIG. 13 shows a system enforcement logic 1304 as a flowchart that depicts how the candidate-employer matching system 100 enforces employer blocking at the data level. System enforcement logic 1304 may begin at a step 1308, where an employer searches for candidates within the candidate-employer matching application 112. At a step 1310, the candidate-employer matching system 100 may retrieve matching candidates based on the employer's search criteria.

A decision 1312 may determine, for each retrieved candidate, whether the searching employer is on the candidate's blocked list. Decision 1312 may evaluate the candidate's block list to identify whether the employer performing the search has been designated as a blocked employer by the candidate.

If the searching employer is on the candidate's blocked list, system enforcement logic 1304 may proceed to a step 1314. At step 1314, the candidate-employer matching system 100 may filter out the candidate from the search results. The filtering at step 1314 may be enforced at the data level such that the blocked employer does not receive any indication that the candidate exists in the system.

If the searching employer is not on the candidate's blocked list, system enforcement logic 1304 may proceed to a step 1316. At step 1316, the candidate-employer matching system 100 may include the candidate in the search results returned to the employer.

The two branches from decision 1312 may converge at a step 1318, where the candidate-employer matching system 100 may return the filtered results to the employer. The filtered results may include candidates who have not blocked the searching employer and may exclude candidates who have designated the searching employer as a blocked employer.

Part C of FIG. 13 shows a visual representation 1306 depicting the resulting effect of employer blocking from two perspectives. From a Candidate's Profile perspective, visual representation 1306 may indicate that the candidate's profile is protected and that blocked employers cannot discover the candidate. From a Blocked Employer's View perspective, visual representation 1306 may display a “No results found” indicator confirming that the candidate does not appear in any search results for the blocked employer.

Visual representation 1306 may include an accompanying note indicating that blocking is enforced at the data level such that blocked employers cannot see the candidate in any context. The data-level enforcement may prevent blocked employers from discovering the candidate through search, browse, recommendations, or direct lookup. By implementing employer blocking at the data level rather than at the user interface level, the candidate-employer matching system 100 may prevent blocked employers from accessing candidate information through direct data queries or application programming interface calls that bypass user interface controls.

The employer blocking feature may be implemented through a blocked employer list stored in association with each candidate's profile. In some cases, the blocked employer list may be stored as a database table containing candidate identifiers and blocked employer identifiers, with an index on the candidate identifier to enable efficient lookup during search operations. The filtering of blocked employers may be enforced across all system contexts in which employer-candidate matching occurs, including candidate search, candidate browse, candidate recommendations, and direct candidate lookup by employer identifier. In some cases, the query logic for retrieving candidates may include a NOT EXISTS or NOT IN clause that excludes candidates whose blocked employer list contains the searching employer's identifier. This data-level enforcement ensures that blocked employers cannot discover the candidate through any system pathway, including direct application programming interface calls that bypass the standard user interface. In some cases, the candidate-employer matching system 100 may also prevent blocked employers from viewing any cached or previously retrieved information about the candidate by invalidating cached data when an employer is added to a candidate's blocked list.

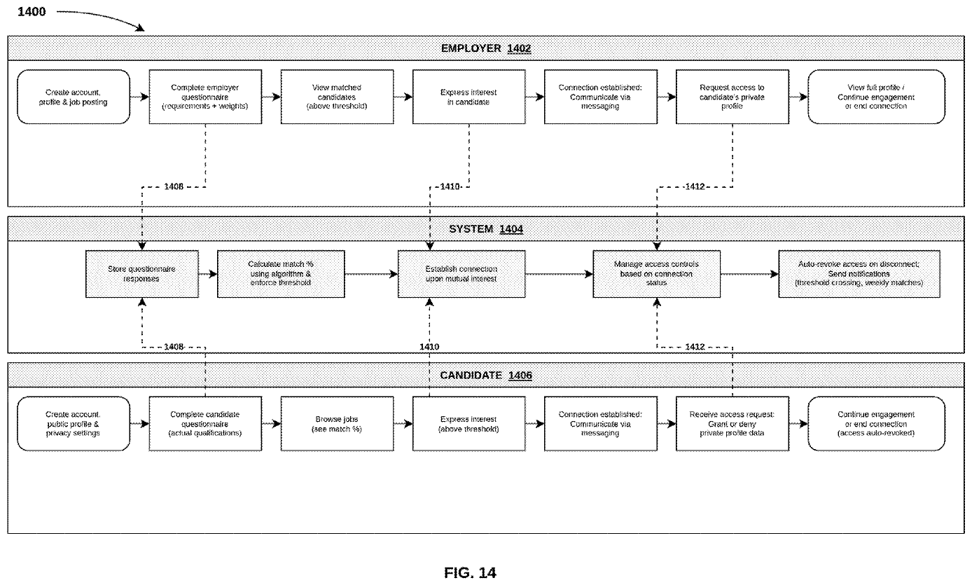

FIG. 14 illustrates an end-to-end user flow diagram 1400 showing a complete user journey for both candidates and employers in the candidate-employer matching application 112. End-to-end user flow diagram 1400 may be arranged as a landscape swim-lane diagram with three horizontal lanes: an employer lane 1402 at the top, a system lane 1404 in the center, and a candidate lane 1406 at the bottom.

Employer lane 1402 may show the employer's journey through the candidate-employer matching application 112. Employer lane 1402 may begin with the employer creating an account, building an employer profile, and creating a job posting. The employer may then complete the employer questionnaire by selecting response requirements and assigning priority weights to questions as described with respect to method 400 of FIG. 4. After completing the employer questionnaire, the employer may view matched candidates whose match percentages meet or exceed the matching percentage threshold. The employer may express interest in candidates above the threshold, communicate with connected candidates via the built-in messaging system, request access to a candidate's private profile, and view the full profile upon candidate approval. The employer may also end a connection at any point during the engagement process.

Employer lane 1402 may further depict controlled job visibility functionality through which employers may determine how much job-related information is disclosed to candidates before and during engagement. In some cases, employers may determine to what extent compensation and salary related information is disclosed before engaging with a particular candidate through total compensation privacy functionality. Employers may work on discreet hiring initiatives to ensure job opening details are shared with highly matched candidates through confidential hiring functionality.

Candidate lane 1406 may show a parallel journey for candidates through the candidate-employer matching application 112. Candidate lane 1406 may begin with the candidate creating an account, building a public profile, and configuring privacy settings. The candidate may then complete the candidate questionnaire by selecting responses that reflect the candidate's actual qualifications, education, and experience as described with respect to method 500 of FIG. 5. After completing the candidate questionnaire, the candidate may browse job postings and view match percentages for each job. The candidate may express interest in jobs where the match percentage meets or exceeds the matching percentage threshold. Upon mutual interest, the candidate may communicate with connected employers via the built-in messaging system. The candidate may respond to profile access requests by granting or denying access to private profile data. The candidate may continue engagement with the employer or end the connection, with access automatically revoked upon disconnection.

In some cases, candidate lane 1406 may depict functionality that allows candidates to express interest in job opportunities or share application materials such as resumes or profile information after completing the questionnaire and meeting the defined compatibility threshold. The candidate-employer matching application 112 may provide simplified or expedited application processes while maintaining the structured compatibility evaluation framework.

In some aspects, the candidate-employer matching system 100 may include an optional AI-assisted candidate profile builder feature that may be an extension of the core implemented matching workflow. The platform may allow a candidate to upload a resume or other candidate document. The candidate-employer matching system 100 may process the uploaded document using optical character recognition (OCR), artificial intelligence, natural language processing, or similar automated document analysis techniques to extract information from the document. The extracted information may include employment history, education history, skills, credentials, job titles, dates, and other professional background data. The candidate-employer matching system 100 may use the extracted information to populate structured candidate profile fields within the candidate-employer matching application 112. In some cases, the candidate may be prompted to confirm, edit, or approve the extracted information before saving it to the candidate's profile. The AI-assisted profile builder may streamline the profile creation process while maintaining candidate control over the accuracy and completeness of profile data.

System lane 1404 may show the role of the candidate-employer matching system 100 at each phase of the user journey. System lane 1404 may depict storing questionnaire responses from both employers and candidates. System lane 1404 may further depict calculating match percentages using the matching algorithm described with respect to method 700 of FIG. 7 and enforcing the matching percentage threshold as described with respect to threshold-based engagement control diagram 1000 of FIG. 10. System lane 1404 may depict establishing connections upon mutual interest between candidates and employers. System lane 1404 may further depict managing access controls based on connection status as described with respect to connection lifecycle and access control diagram 1100 of FIG. 11. System lane 1404 may also depict automatically revoking access when a connection ends and sending notifications including threshold-crossing alerts and weekly match summaries to users who have enabled notification preferences.

In some aspects, the candidate-employer matching system 100 may include an optional AI-based recommendation engine that may be an extension of the core implemented matching workflow. The recommendation engine may analyze structured questionnaire responses, employer-defined criteria, match percentages, candidate profile information, job preferences, interaction history, connection history, and prior matching outcomes to recommend job opportunities to candidates or suggest candidate matches to employers. The recommendation engine may operate in addition to the core compatibility scoring algorithm described with respect to method 700 of FIG. 7. In some cases, the recommendation engine may be used to rank, prioritize, filter, or suggest candidate-job pairings within the platform. In some cases, the recommendation engine may utilize machine learning, artificial intelligence, or statistical modeling techniques to identify patterns in candidate-employer interactions and improve the relevance of recommendations over time. The recommendation engine may present recommendations to candidates as suggested job opportunities or to employers as suggested candidate matches, while maintaining the confidentiality protections provided by the plurality of confidentiality features 200.

In some cases, the candidate-employer matching system 100 may generate aggregate statistics for employers without revealing any individual candidate's identity. The aggregate statistics may include the distribution of match scores across the candidate pool for a particular job posting, identification of which questionnaire questions are most differentiating among candidates, average match percentages by job category or role type, and trends in candidate qualifications over time. The candidate-employer matching system 100 may compute these aggregate statistics by processing candidate data in a manner that prevents identification of individual candidates, such as by requiring a minimum number of candidates before generating statistics for a particular category or by rounding percentage values to prevent inference of individual scores. This privacy-preserving data processing approach may allow employers to gain insights into the candidate pool and refine their questionnaire configurations while maintaining candidate anonymity. In some cases, the aggregate statistics may be presented through a dashboard interface that displays visualizations such as histograms of match score distributions or ranked lists of differentiating questions without associating any data with specific candidate identifiers.

In some cases, the candidate-employer matching system 100 may generate aggregated or anonymized analytics for employers based on candidate questionnaire responses, match percentages, candidate interest activity, resume-sharing activity, or other platform interactions. The analytics may be presented without disclosing individual candidate identities or private candidate information unless the candidate has authorized disclosure. Such analytics may help employers understand candidate pool characteristics, evaluate job-posting criteria, adjust questionnaire weights or response evaluations, and improve recruiting outcomes while preserving candidate confidentiality. In some cases, the analytics may include metrics such as the number of candidates expressing interest in a job posting, the rate at which candidates share resumes with employers, or aggregate trends in candidate qualifications across job categories. The privacy-preserving analytics feature may enable employers to refine their hiring strategies based on platform data while maintaining the confidentiality protections provided by the candidate-employer matching system 100.

In some aspects, the candidate-employer matching system 100 may include an optional integration with one or more employer applicant tracking systems (ATS) to transmit data between the platform and the employer's ATS. The integration may transmit candidate data, job posting data, match data, questionnaire data, application data, resume data, interview data, or connection data between the candidate-employer matching system 100 and the employer's ATS. For example, after a candidate satisfies a matching percentage threshold, expresses interest in a job posting, shares a resume with an employer, applies to a role, establishes a connection with an employer, or is advanced by the employer in the hiring process, the candidate-employer matching system 100 may transmit relevant candidate or match information to the employer's ATS. The integration may also receive job posting information, employer hiring status updates, candidate updates, interview scheduling information, or other recruiting workflow data from the ATS. In some cases, the ATS integration may maintain the confidentiality protections described herein, such that private candidate information is transmitted to the employer's ATS only when the candidate has authorized disclosure.

In some aspects, the candidate-employer matching system 100 may include an optional in-application interview scheduling and video interview coordination feature. This feature may allow the candidate-employer matching system 100 to serve as a single application for early-stage candidate screening before an employer proceeds to an in-person interview or later-stage hiring process. After a candidate and employer satisfy the applicable matching percentage threshold and establish a connection, the employer may schedule an initial screening interview directly within the candidate-employer matching application 112. The interview may be a video interview, phone interview, or other meeting type. The candidate-employer matching system 100 may allow the employer to propose available times, allow the candidate to accept, decline, or select from available time slots, and generate or associate a video meeting link with the scheduled interview. The scheduled interview may be stored in the platform and may be associated with the candidate, employer, job posting, match record, and connection record. This feature may allow the candidate-employer matching system 100 to support a structured workflow from questionnaire-based matching, to candidate-employer connection, to initial interview screening, before any in-person interview or external hiring step. In some cases, the interview scheduling and coordination may maintain the confidentiality protections described herein, such that interview details and scheduling information are accessible only to the connected candidate and employer.

End-to-end user flow diagram 1400 may include dashed arrows connecting the three lanes to show cross-lane interactions. A questionnaire data interaction 1408 may depict how questionnaire responses from both the employer and the candidate flow to system lane 1404 for matching. Questionnaire data interaction 1408 may show employer questionnaire responses including response requirements and priority weights flowing from employer lane 1402 to system lane 1404, and candidate questionnaire responses flowing from candidate lane 1406 to system lane 1404. The questionnaire framework may be extended to allow candidates to select multiple responses for certain questions where multiple qualifications, preferences, or areas of experience may apply.

A mutual interest interaction 1410 may depict how expressions of interest from both the employer and the candidate converge at system lane 1404 for mutual-interest evaluation and connection establishment. Mutual interest interaction 1410 may show the employer's expression of interest in a candidate flowing from employer lane 1402 to system lane 1404, and the candidate's expression of interest in a job flowing from candidate lane 1406 to system lane 1404. When both parties have expressed interest, system lane 1404 may establish a connection that enables messaging and further interaction between the candidate and the employer.

An access control interaction 1412 may depict how profile access requests and grants flow through the access control layer in system lane 1404. Access control interaction 1412 may show the employer's profile access request flowing from employer lane 1402 to system lane 1404, and the candidate's access grant or denial flowing from candidate lane 1406 to system lane 1404. System lane 1404 may enforce access controls at the server level based on connection status and candidate authorization, as described with respect to server-level access control gate 312 of FIG. 3.

A number of implementations have been described. Nevertheless, it will be understood that various modifications may be made without departing from the spirit and scope of the disclosure. Accordingly, other implementations are within the scope of the following claims.

1. A method for matching job candidates with employment opportunities, the method comprising:
receiving, by a server, employer questionnaire data comprising a plurality of employer responses to a plurality of questions associated with a job posting, wherein each employer response indicates an evaluation designation for each of a plurality of response options, and wherein each question is assigned an employer-defined priority weight;
receiving, by the server, candidate questionnaire data comprising a plurality of candidate responses to the plurality of questions, wherein the plurality of questions in the candidate questionnaire data correspond to the plurality of questions in the employer questionnaire data;
for each question in the plurality of questions, comparing, by the server, the candidate response to the employer response to determine a match type, wherein the match type comprises one of an exact match, a partial match, or no match;
assigning, by the server, a match score to each question based on the determined match type;
calculating, by the server, a weighted score for each question by multiplying the match score by the employer-defined priority weight assigned to the question;
calculating, by the server, a total candidate score by summing the weighted scores for all questions;
calculating, by the server, a match percentage by dividing the total candidate score by a maximum possible score; and
transmitting, by the server, the match percentage to a client device for display in a user interface.

2. The method of claim 1, wherein the match score comprises 1.0 for an exact match, 0.5 for a partial match, and 0.0 for no match.

3. The method of claim 1, wherein the employer-defined priority weight comprises one of a first weight value indicating a high priority criterion, a second weight value indicating a medium priority criterion, or a third weight value indicating a low priority criterion.

4. The method of claim 3, wherein the first weight value is 3, the second weight value is 2, and the third weight value is 1.

5. The method of claim 1, wherein the maximum possible score is calculated by summing all employer-defined priority weights multiplied by a maximum match score value.

6. The method of claim 1, further comprising:
determining, by the server, whether the match percentage meets or exceeds a matching percentage threshold; and
transmitting, by the server, an engagement control state to the client device, wherein the engagement control state indicates whether an engagement control element in the user interface is enabled or disabled based on whether the match percentage meets or exceeds the matching percentage threshold.

7. The method of claim 6, wherein the engagement control element comprises at least one of an express interest button, a not interested button, or a share resume button.

8. The method of claim 1, further comprising:
detecting, by the server, a change to the employer questionnaire data or the candidate questionnaire data;
identifying, by the server, affected candidate-job pairs based on the detected change;
automatically recalculating, by the server, match percentages for the affected candidate-job pairs; and
transmitting, by the server, updated match percentages to client devices associated with the affected candidate-job pairs.

9. The method of claim 8, further comprising:
determining, by the server, whether a recalculated match percentage crosses the matching percentage threshold; and
transmitting, by the server, a threshold-crossing notification to a client device when the recalculated match percentage crosses the matching percentage threshold.

10. A method for controlling access to candidate profile data in a candidate-employer matching system, the method comprising:
maintaining, by a server, candidate profile data comprising publicly visible information and private information associated with a candidate, wherein the publicly visible information is viewable by employers and the private information is restricted from employer access until the candidate authorizes disclosure;
receiving, by the server, a request from an employer device for candidate profile data;
determining, by the server, whether the candidate has authorized disclosure of the private information to the employer;
when the candidate has not authorized disclosure, restricting, by the server, the employer to viewing the publicly visible information; and
when the candidate has authorized disclosure, permitting, by the server, the employer to view the private information.

11. The method of claim 10, wherein the publicly visible information is stored in a public data store comprising a user profiles table storing at least one of an about me field, an experience description field, or an education description field.

12. The method of claim 10, wherein the private information is stored in a private data store separate from the public data store, the private data store comprising at least one of a resumes table, an experiences table, or an education table.

13. The method of claim 10, further comprising:
enforcing, by a server-level access control gate interposed between a public data store and a private data store, access restrictions based on a connection status between the candidate and the employer, wherein the server-level access control gate blocks access to the private data store when no connection exists and permits access to the private data store when a connection exists and the candidate has granted access; and
automatically revoking, by the server-level access control gate, the employer's access to the private data store in response to detecting that a connection between the candidate and the employer has ended.

14. The method of claim 10, further comprising:
maintaining, by the server, a blocked employer list associated with the candidate;
receiving, by the server, a search request from the employer device;
determining, by the server, whether the employer is on the blocked employer list; and
when the employer is on the blocked employer list, filtering, by the server, the candidate from search results returned to the employer device.

15. The method of claim 14, wherein the filtering is enforced at a data level such that the employer cannot discover the candidate through search, browse, recommendations, or direct lookup.

16. A candidate-employer matching system comprising:
a server comprising a processor and a memory;
a database communicatively coupled to the server;
a candidate-employer matching application executable by the processor and configured to:
receive employer questionnaire data comprising employer responses to a plurality of questions associated with a job posting, wherein each question is assigned an employer-defined priority weight;
receive candidate questionnaire data comprising candidate responses to the plurality of questions;
calculate a match percentage by comparing the candidate responses to the employer responses and applying the employer-defined priority weights; and
transmit the match percentage to a client device; and
a plurality of confidentiality features configured to safeguard personal and professional data for job candidates and employers, the plurality of confidentiality features comprising at least one of anonymous job matching, job candidate controlled profile visibility, or secure messaging and profile access control.

17. The system of claim 16, wherein the database comprises a public data store configured to store public candidate data and a private data store configured to store private candidate data, wherein the public data store and the private data store are separate storage locations.

18. The system of claim 17, further comprising a server-level access control gate configured to:
determine a connection status between a candidate and an employer;
block access to the private data store when the connection status indicates that no connection exists;
permit access to the private data store when the connection status indicates that a connection exists and the candidate has granted access; and
automatically revoke access to the private data store when a connection between the candidate and the employer ends.

19. The system of claim 16, wherein the candidate-employer matching application is further configured to:
detect a change to the employer questionnaire data or the candidate questionnaire data;
identify affected candidate-job pairs based on the detected change; and
automatically recalculate match percentages for the affected candidate-job pairs.

20. The system of claim 16, wherein the database further comprises a questionnaire version tracking data model configured to store a history of questionnaire versions, the questionnaire version tracking data model comprising:
a questionnaire setup table configured to store instances of employer job-post questionnaires;
a questionnaire question setups table configured to store employer response evaluations and question weights for each question; and
a questionnaire question answers table configured to store candidate responses to questionnaires.
